(19) United States
(12) Patent Application Publication
(10) Pub. No.: US 2024/0055727 A1
(43) Pub. Date: Feb. 15, 2024

(54) LITHIUM CYLINDRICAL CELL CONFIGURED FOR DIRECT ELECTRODE-SEPARATOR CONTACT

(71) Applicant: Lyten, Inc., San Jose, CA (US)

(72) Inventors: Jeffrey Bell, Santa Monica, CA (US); Engin Tuncer, Milpitas, CA (US); Zach Favors, Reno, NV (US); Brandan Taing, Sunnyvale, CA (US); Jesse Baucom, Santa Clara, CA (US)

(73) Assignee: Lyten, Inc., San Jose, CA (US)

(21) Appl. No.: 18/203,558

(22) Filed: May 30, 2023

Related U.S. Application Data
(60) Provisional application No. 63/396,531, filed on Aug. 9, 2022.

(51) Int. Cl. H01M 50/46; H01M 50/107; H01M 50/119; H01M 50/497; H01M 50/566; H01M 4/134; H01M 4/136; H01M 4/40; H01M 4/58; H01M 4/66; H01M 50/494

(52) U.S. Cl. CPC H01M 50/46; H01M 50/107; H01M 50/119; H01M 50/497; H01M 50/566; H01M 4/134; H01M 4/136; H01M 4/405; H01M 4/5815; H01M 4/661; H01M 50/494; H01M 2004/027

(57) ABSTRACT

A lithium-sulfur cylindrical cell. The cell includes a cylindrical shell defining an inner volume, and a jelly roll disposed within the inner volume. The jelly roll includes an anode comprising lithium, where the anode is configured as a freestanding assembly. Additionally, the jelly roll comprises a cathode comprising sulfur. Further, the jelly roll comprises a first separator between a first side of the anode and a first side of the cathode. In cylindrical cell formats, the jelly roll comprises a windable second separator. As the jelly roll is wound, the second separator may come in direct contact with both a second side of the anode and with a second side of the cathode. Alternatively, as the jelly roll is wound, the second separator may come in direct contact with the second side of the anode and with a cathode current collector.

### CROSS-REFERENCE TO RELATED APPLICATIONS

The present application claims priority to and the benefit of U.S. Provisional Patent Application No. 63/396,531, filed Aug. 9, 2022, entitled “ENERGY STORAGE DEVICES EXHIBITING IMPROVED THERMAL AND ELECTRICAL CHARACTERISTICS AND REDUCED MASS, AND METHODS OF MAKING THE SAME,” which is assigned to the assignee hereof; the disclosures of all prior applications are considered part of and are incorporated by reference in this patent application.

### FIELD OF THE INVENTION

The present invention relates to lithium-based batteries, and more specifically, to lithium-sulfur batteries in cylindrical or jelly roll form factors.

### BACKGROUND

Currently, cylindrical cell batteries benefit from use of lithium. For example, lithium-sulfur (or other lithium alloy composites) may provide rechargeable capabilities. Additionally, use of lithium-sulfur may allow for higher theoretical energy density, lower manufacturing costs, and lower environmental impact compared to lithium-ion (Li-ion) batteries. However, such cylindrical lithium-based batteries may encounter a number of issues. For example, the volume and weight of the case contributes (in excess of 10-13%) significantly to the mass of the overall cylindrical cell. As such, the battery capacity of lithium-based cylindrical cells is currently a fraction of its theoretical capacity (particularly if the volume of the case can be decreased).

As such, there is thus a need for addressing these and/or other issues associated with the prior art.

### SUMMARY

A freestanding lithium cylindrical cell may be provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In one embodiment, the anode may consist essentially of pure lithium. Additionally, the anode may comprise a lithium alloy including one or more of sulfur, magnesium, aluminum, alumina, lithium titanate, lithium lanthanum zirconium oxide (LLZO), calcium, tellerium, silicon, tin, zinc, or nickel. Further, the anode may comprise a lithium-magnesium anode, and/or a pure lithium anode. Further, the anode may comprise one of a lithium metal alloy anode, or a lithium composite anode.

In another embodiment, the jelly roll may include a current collector. The current collector may comprise at least one of copper, or nickel. Additionally, the jelly roll may comprise an assembly, wherein the assembly excludes copper.

In another embodiment, the battery may further comprise copper inlays within the jelly roll for tab welding. Additionally, at least one of the first separator or the second separator may be a carrier film for the anode. Further, the battery may further comprise an electrolyte disposed in the battery. The electrolyte may be configured to inhibit transport of lithium-containing polysulfide intermediate species from the cathode to the anode.

In another embodiment, the anode may be a solid lithium layer, and a current collector may be coupled to the anode. Additionally, the jelly roll may be wound using one or more mandrels.

In another embodiment, a top surface of the jelly roll may be not in contact with a top lid of the cylindrical shell. Additionally, a bottom surface of the jelly roll may be at least partially in contact with a negative contact surface of the cylindrical shell. Further, a casing of the battery may be formed from one or more of aluminum or steel. In one embodiment, a positive terminal of the battery may be welded to a current collector electrically coupled to the cathode, and a negative contact surface may be welded to a current collector coupled to the anode.

In another embodiment, the anode may comprise an alloy selected to surpass a minimum shear strength, where the minimum shear strength surpasses 50 N/cm2 Additionally, the anode may be an alloy selected to surpass a minimum mechanical strength, where the minimum mechanical strength surpasses 160 N/cm2.

In another embodiment, at least one of the first separator or the second separator may be configured for ion flow. Additionally, the battery may further comprise an inlay comprising copper, where the inlay may be one of a vertical strip or a horizontal strip. The vertical strip may be stamped into the anode, and the horizontal strip may be inlayed within the anode.

In another embodiment, the anode may function as a current collector. Additionally, the anode may consist of pure lithium, and at least one of the first separator or the second separator include a carrier film, where the carrier film increases the tensile strength of the pure lithium. Further, the anode may be a lithium alloy, and at least one of the first separator or the second separator may not include a carrier film.

In another embodiment, the cylindrical shell may have a diameter in a range from approximately 18.4 millimeter (mm) to approximately 18.6 mm and a length in a range from approximately 65.1 mm to approximately 65.3 mm. Additionally, the cylindrical shell may be congruent with an 18560 cell. Further, at least one of the anode or the cathode may not include a tab.

In another embodiment, the freestanding assembly may be a substrate-less electrode. Additionally, the freestanding assembly is a copper-free assembly. Further, the anode may lack a separate layer for a current collector. For example, the may lithium function as a current collector.

### BRIEF DESCRIPTION OF THE DRAWINGS

FIG. 1A illustrates prior art.

FIG. 1B-1 illustrates a cross-cut perspective of a cell with a free standing lithium anode, in accordance with one embodiment.

FIG. 1B-2 illustrates a cross-cut perspective of a cell with a free standing lithium anode, in accordance with one embodiment.

FIG. 1C-1 illustrates a cross-cut perspective of FIG. 1B-1 in the context of a cylindrical cell, in accordance with one embodiment.

FIG. 1C-2 illustrates a cross-cut perspective of FIG. 1B-1 in the context of a cylindrical cell, in accordance with one embodiment.

FIG. 1C-3 illustrates a cross-cut perspective of FIG. 1B-1 in the context of a cylindrical cell, in accordance with one embodiment.

FIG. 1C-4 illustrates a cross-cut perspective of FIG. 1B-1 in the context of a cylindrical cell, in accordance with one embodiment.

FIG. 1C-5 illustrates a cross-cut perspective of FIG. 1B-2 in the context of a cylindrical cell, in accordance with one embodiment.

FIG. 1C-6 illustrates a cross-cut perspective of FIG. 1B-2 in the context of a cylindrical cell, in accordance with one embodiment.

FIG. 1C-7 illustrates a cross-cut perspective of FIG. 1B-2 in the context of a cylindrical cell, in accordance with one embodiment.

FIG. 1C-8 illustrates a cross-cut perspective of FIG. 1B-2 in the context of a cylindrical cell, in accordance with one embodiment.

FIG. 1D illustrates a cross-cut perspective of a cylindrical cell with a free standing lithium anode, in accordance with one embodiment.

FIG. 2 illustrates a side perspective of a cylindrical cell with a free standing lithium anode, in accordance with one embodiment.

FIG. 3 illustrates a close-up perspective of a cylindrical cell with a free standing lithium anode, in accordance with one embodiment.

FIG. 4 illustrates a top-down perspective of a cylindrical cell with a free standing lithium anode, in accordance with one embodiment.

FIG. 5 illustrates a case for a cylindrical cell with a free standing lithium anode, in accordance with one embodiment.

FIG. 6 illustrates an assembled cylindrical cell with a free standing lithium anode, in accordance with one embodiment.

FIG. 7 illustrates an assembled cylindrical cell with a free standing lithium anode, in accordance with one embodiment.

FIG. 8 illustrates a jelly roll configuration for a cylindrical cell with a free standing lithium anode, in accordance with one embodiment.

FIG. 9 illustrates a current collector for a cylindrical cell with a free standing lithium anode, in accordance with one embodiment.

FIG. 10 illustrates a gasket for a cylindrical cell with a free standing lithium anode, in accordance with one embodiment.

FIG. 11 illustrates a positive terminal for a cylindrical cell with a free standing lithium anode, in accordance with one embodiment.

FIG. 12 illustrates a top insulator for a cylindrical cell with a free standing lithium anode, in accordance with one embodiment.

FIG. 13 illustrates a reduced copper-configured cylindrical cell, in accordance with one embodiment.

FIG. 14 illustrates a reduced copper-configured cylindrical cell, in accordance with one embodiment.

FIG. 15 illustrates a free standing lithium anode, in accordance with one embodiment.

FIG. 16 illustrates production images for a cylindrical cell with a free standing lithium anode, in accordance with one embodiment.

FIG. 17 illustrates production images for a cylindrical cell with a free standing lithium anode, in accordance with one embodiment.

FIG. 18 illustrates computed tomography scans of a cylindrical cell with a free standing lithium anode, in accordance with one embodiment.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Commercial lithium (Li)-ion batteries have been made into cylindrical and jelly roll prismatic form factors. Given that Li—S batteries have higher theoretical specific capacity and specific energy, it is desirable to make cylindrical or jelly roll prismatic Li—S batteries. A conventional cylindrical or a jelly roll prismatic battery cell requires jelly rolling of a cathode, an anode, and separators in a radial bending fashion. The cathode and the anode must have a robust mechanical structure to withstand the bending forces in the winding process to avoid any internal short circuits or capacity decrease.

A Li—S battery that may be capable of powering electric vehicles, energy storage systems, or satellites due to its high theoretical energy density is associated with several undesirable characteristics. For example, the polysulfide shuttle effect may significantly decrease the cycling stability, cause irreversible loss of sulfur, and even cause severe lithium anode corrosion. A volume expansion of cathode active materials caused by the cathode reaction during the discharge cycle of the Li—S battery can damage the mechanical structure of the cathode and cause potential hazards. Further, the volume and weight of the case may contribute (in excess of 10-13%) significantly to the mass of the overall cylindrical cell.

Given the fragility of using lithium within battery structures (particularly within the context of jelly roll configuration), lithium is often paired with a substrate (such as copper) to reinforce its tensile and mechanical strength. For example, a pure lithium anode in a cylindrical cell is likely to break apart due to the wind tension.

The present disclosure resolves these and other issues with lithium cylindrical batteries. In particular, a freestanding lithium cylindrical cell is provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In various implementations, the Li—S battery contains a jelly roll within a battery shell. In some aspects, the Li—S battery may contain one or more tabs to connect the cathode and the anode of the Li—S battery to the positive and negative terminal, respectively, of the shell.

Particular implementations of the subject matter described in this disclosure can be implemented to realize one or more of the following potential advantages. Existing cylindrical or jelly roll prismatic batteries are limited to Li-ion battery chemistries. Such chemistries have imposed limitations on battery capacities and energy densities regardless of research and development or breakthroughs on composition materials. As a result, existing Li-ion batteries may not be used for certain applications that would require high energy densities such as an energy storage system for powering a satellite or an electric vehicle capable of a longer range. In some implementations, the techniques disclosed herein can be used to manufacture a cylindrical or jelly roll prismatic Li—S battery with a much higher battery capacity and energy densities compared to commercial Li-ion batteries.

Additionally, the techniques disclosed herein can be used to manufacture an electrode that has reduced overall volume (due to it being freestanding) and increased energy density (wh/kg and wh/L).

### DEFINITIONS AND USE OF FIGURES

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Within the context of the present description, a freestanding electrode refers to an electrode that lacks a substrate. For example, in various embodiments, a freestanding electrode may include an electrode constructed of pure lithium, a lithium alloy, a lithium composite, a pure lithium with carrier film, etc. In this manner, a freestanding electrode may not require a typical copper substrate (or any other typical substrate) to function. In one embodiment, a freestanding electrode may require a carrier film.

### Descriptions of Exemplary Embodiments

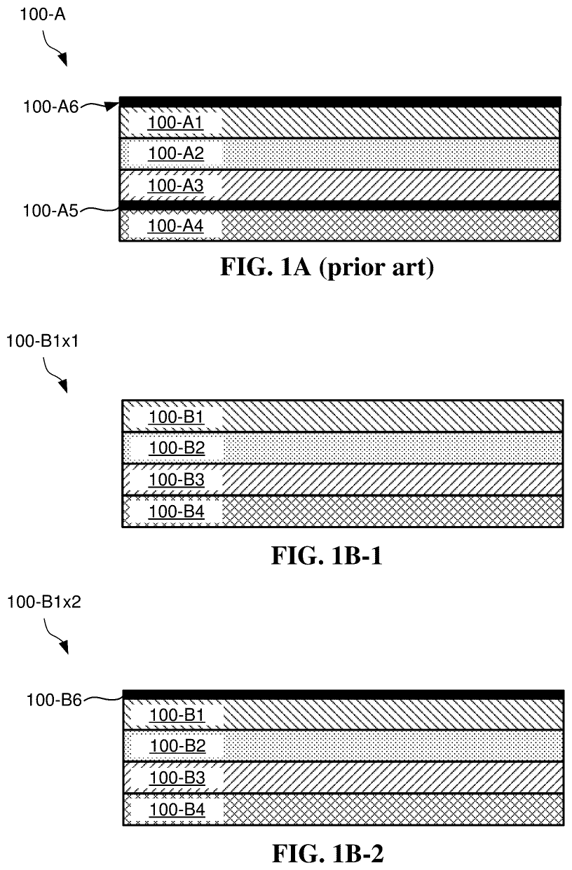

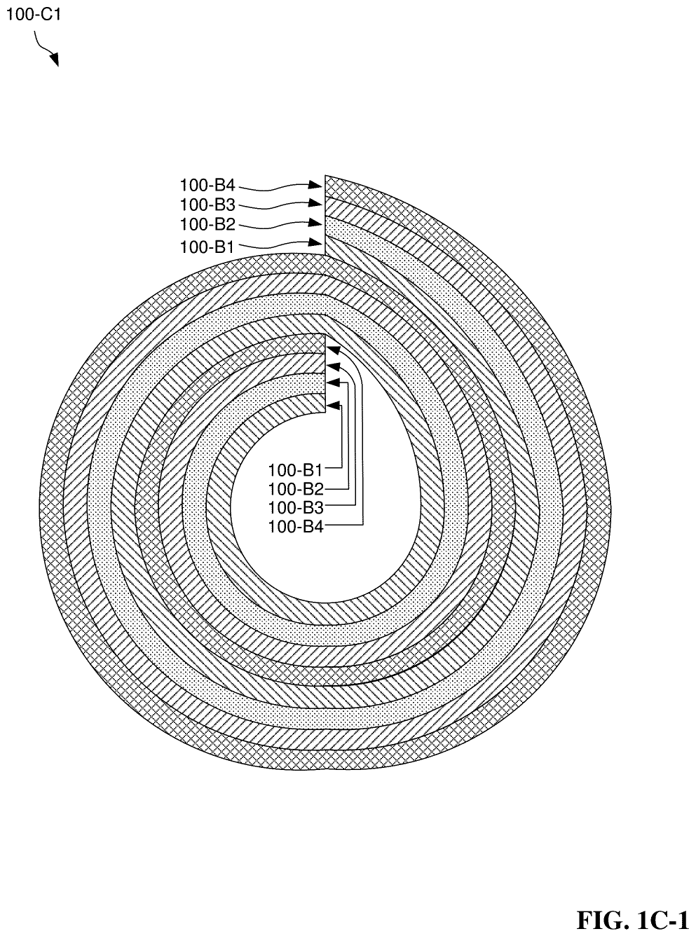

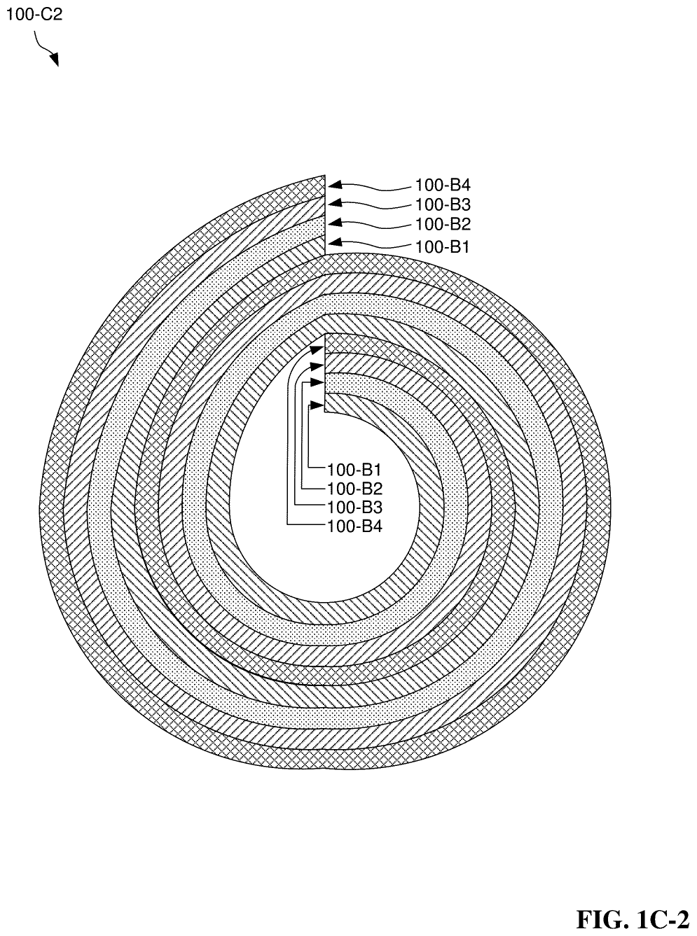

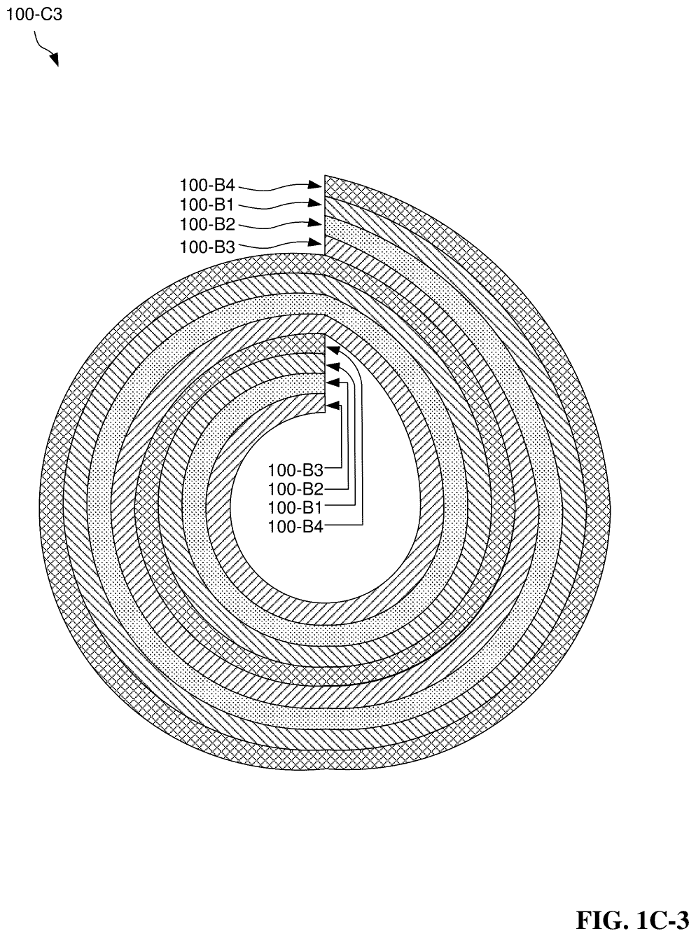

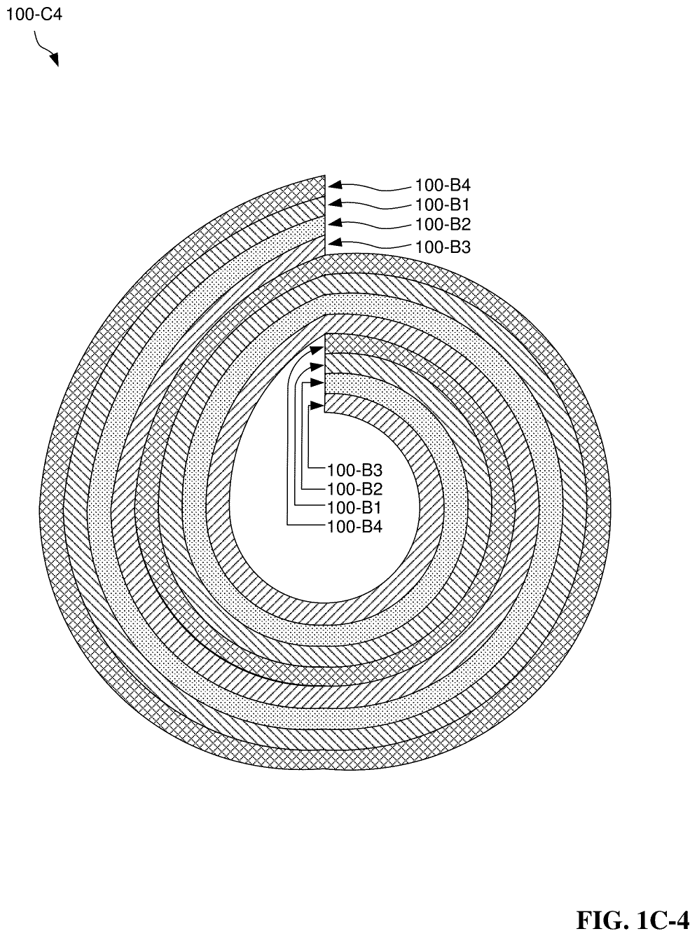

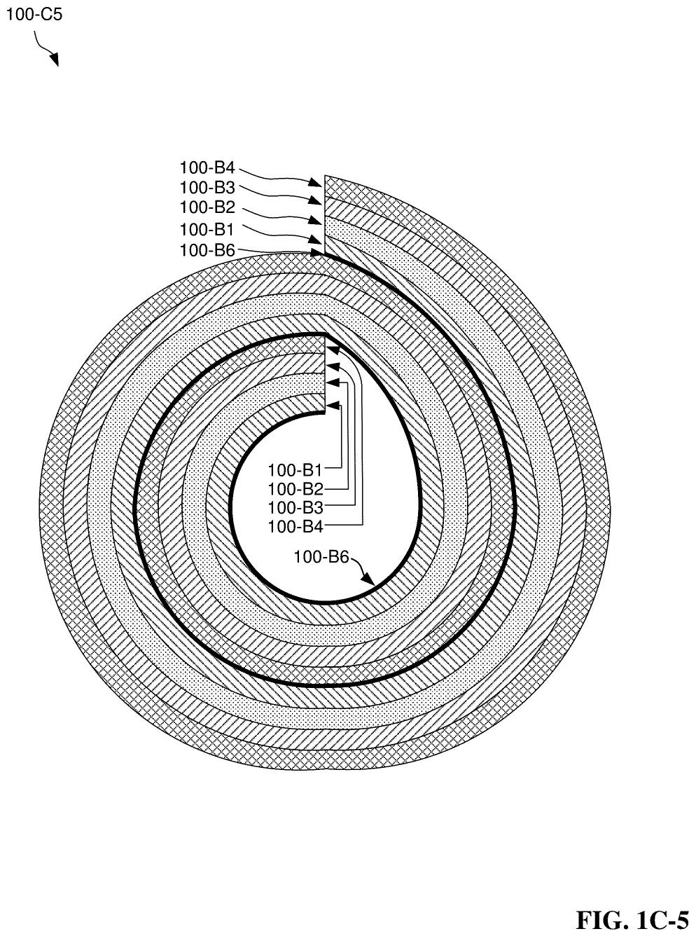

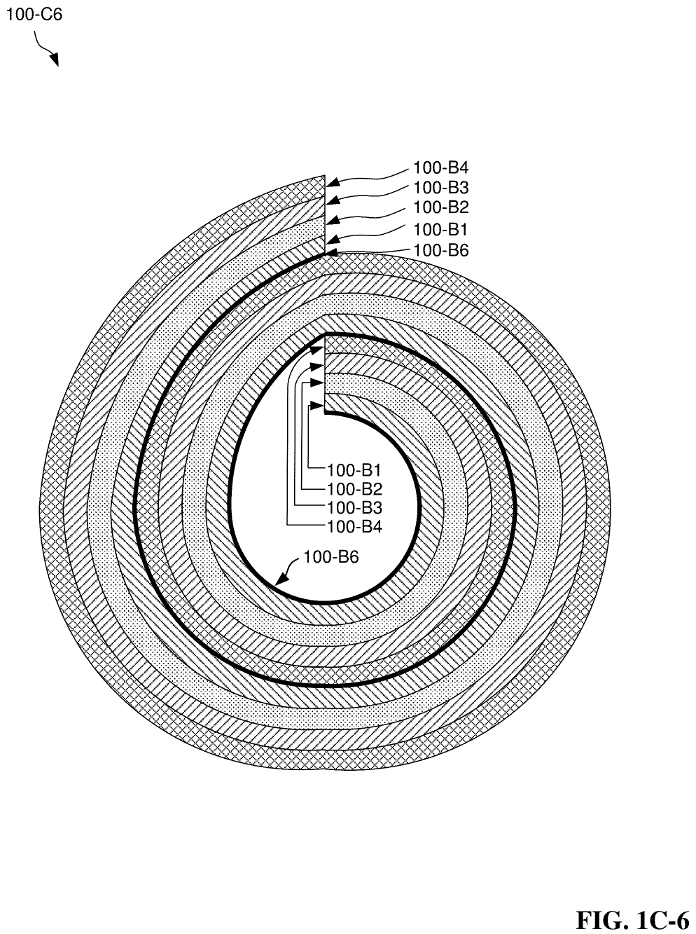

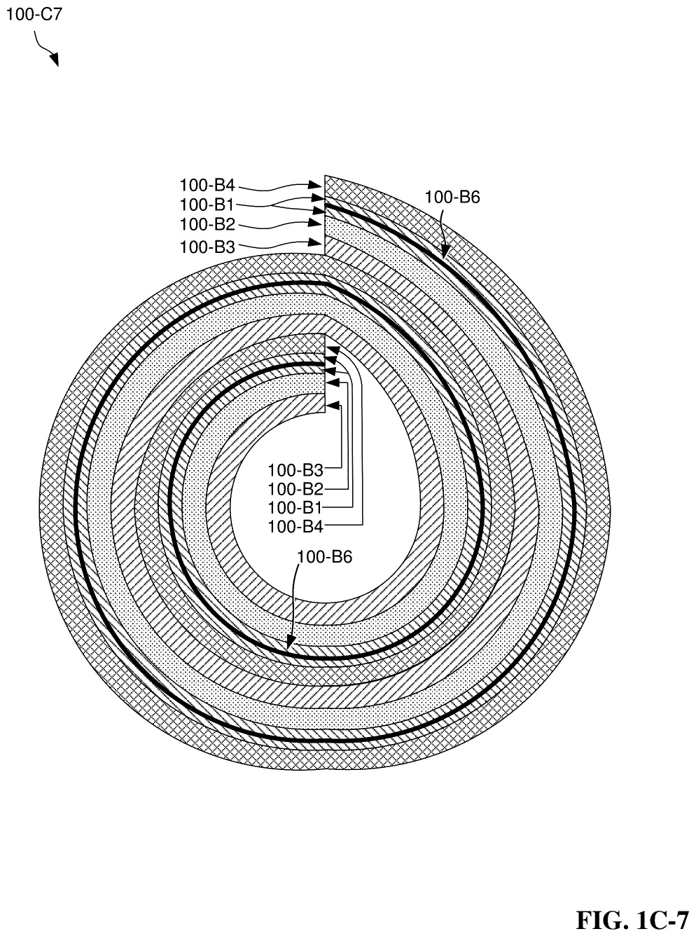

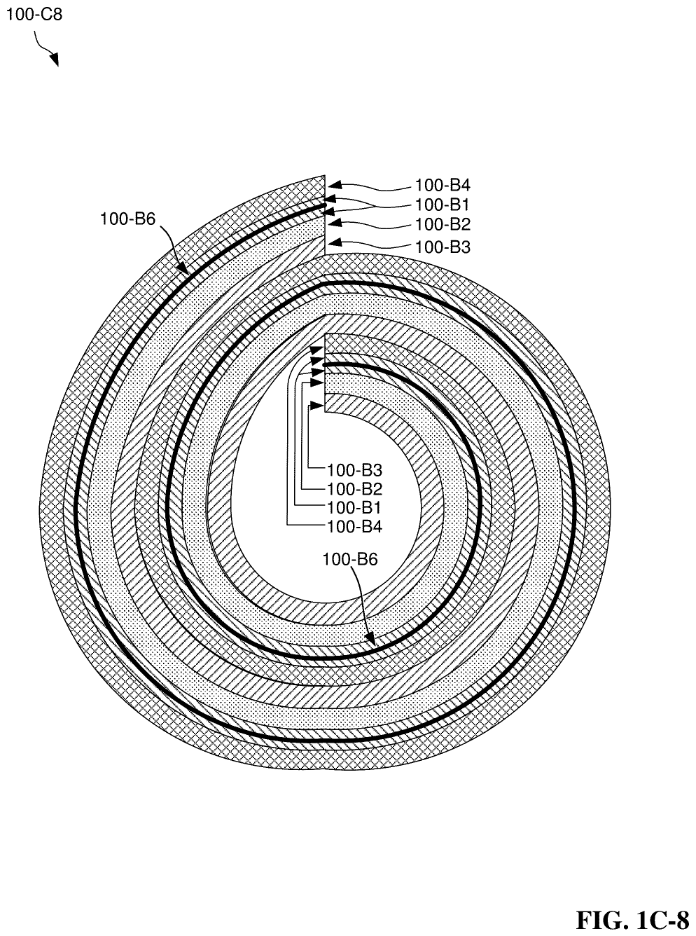

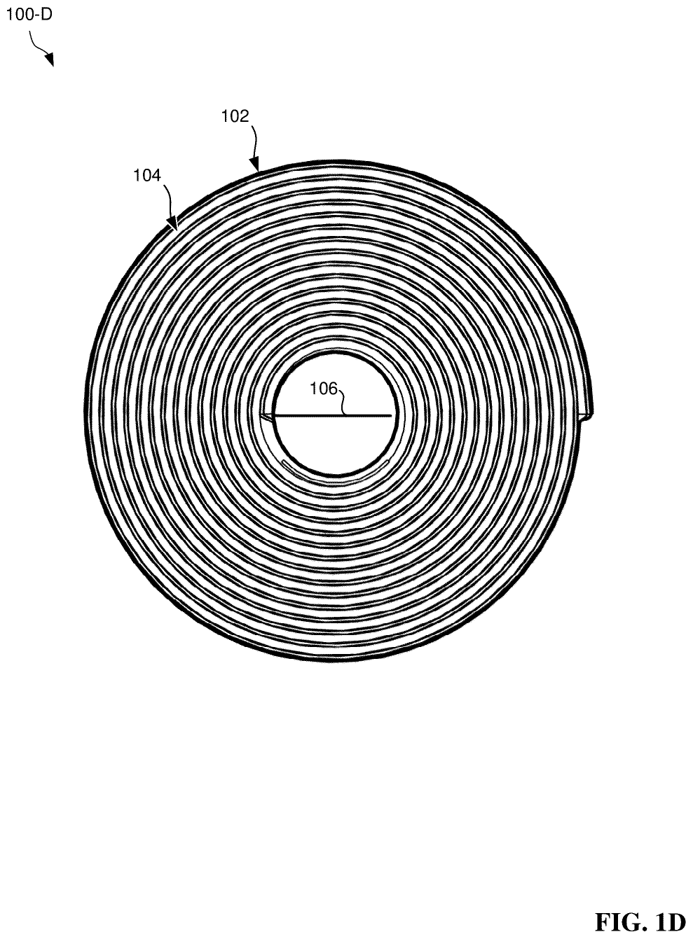

FIG. 1A illustrates prior art 100-A. As shown, the prior art 100-A displays a cross-cut layered display of a cylindrical cell (prior to being wound). The prior art 100-A shows a cell containing a cathode 100-A1, a first separator 100-A2, an anode 100-A3, a second separator 100-A4, an anode substrate 100-A5, and a cathode current collector 100-A6. In conventional systems, if lithium were primarily used, for example, in the anode 100-A3, the anode substrate 100-A5 may include a layer of copper. The copper may be used both as a current collector and to reinforce the anode 100-A3. In this manner, a first side of the anode 100-A3 comes in contact with a first side of the first separator 100-A2, and a second side of the anode 100-A3 comes in contact with a first side of the anode substrate 100-A5.

FIG. 1B-1 illustrates a cross-cut perspective 100-B1x1 of a cell with a free standing lithium anode, in accordance with one embodiment. The cross-cut perspective 100-B1x1 shows a cross-cut layered display of a cylindrical cell (prior to being wound). The cross-cut perspective 100-B1x1 shows a cell containing a cathode 100-B1, a first separator 100-B2, an anode 100-B3, and a second separator 100-B4. In comparing the cross-cut perspective 100-B to the prior art 100-A, it is to be appreciated that the cross-cut perspective 100-B does not include a substrate for the anode 100-B3. In this manner, the anode 100-B3 is a free-standing layer (without a substrate) which differs from conventional systems.

This approach of having a free-standing layer for the anode was hitherto impossible to achieve. For example, using conventional techniques, if an anode constructed primarily of lithium were wound for a cylindrical cell and which did not have a substrate (to increase its tensile strength), the anode would crack (and otherwise be rendered unfit for use). Thus, the techniques disclosed herein allow for a free-standing anode (constructed primarily of lithium and/or lithium alloys, as detailed further herein) which does not require use of a substrate in order to function.

With this context, it is to be appreciated that a first side of the anode 100-B3 comes in contact with a first side of the first separator 100-B2, and a second side of the anode 100-B3 comes in contact with a first of the second separator 100-B4. In comparing FIG. 1B-1, again, to FIG. 1A, it is to be appreciated that with prior art systems, the anode typically would sandwiched between a separator and an anode substrate, whereas with FIG. 1B-1, the anode 100-B3 is sandwiched directly between the first separator 100-B2 and the second separator 100-B4.

It is to be appreciated that the anode substrate (such as the anode substrate 100-B5) may include any substrate and/or current collector that is layered next to the anode (such as the anode 100-A3).

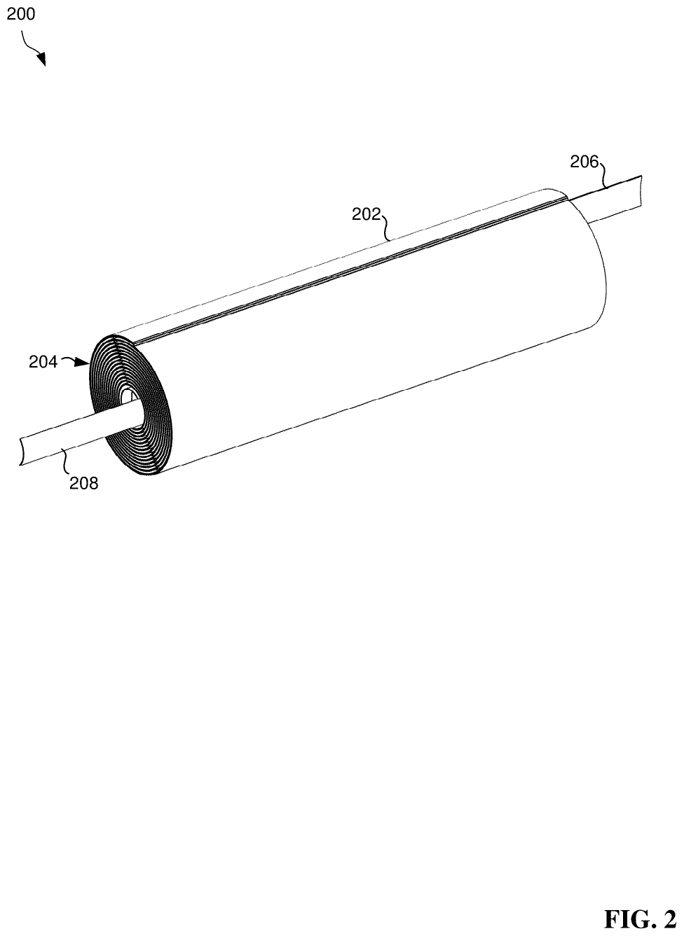

FIG. 1B-2 illustrates a cross-cut perspective 100-B1x2 of a cell with a free standing lithium anode, in accordance with one embodiment. The cross-cut perspective 100-B1x2 shows a cross-cut layered display of a cylindrical cell (prior to being wound). The cross-cut perspective 100-B1x2 shows a cell containing a cathode 100-B1, a first separator 100-B2, an anode 100-B3, a second separator 100-B4, and a cathode current collector 100-B6. In comparing the cross-cut perspective 100-B2 to the prior art 100-A, it is to be appreciated that the cross-cut perspective 100-B does not include a substrate for the anode 100-B3, but does include a substrate for the cathode 100-B1. In this manner, the anode 100-B3 is a free-standing layer (without a substrate) which differs from conventional systems, and the cathode 100-B1 may still include a substrate (such as a current collector). It is noted that the free-standing capabilities of the anode 100-B3 apply equally to the FIG. 1B-2 as previously discussed within the context of FIG. 1B-1.

FIG. 1C-1 illustrates a cross-cut perspective 100-C1 of FIG. 1B-1 in the context of a cylindrical cell, in accordance with one embodiment. As an option, the cross-cut perspective 100-C1 may be implemented in the context of any one or more of the embodiments set forth in any previous and/or subsequent figure(s) and/or description thereof. Of course, however, the cross-cut perspective 100-C1 may be implemented in the context of any desired environment. Further, the aforementioned definitions may equally apply to the description below.

As shown, the cross-cut perspective 100-C1 shows a cylindrical cell in a first counter-clockwise configuration containing a cathode 100-B1, a first separator 100-B2, an anode 100-B3, and a second separator 100-B4. Within the context of a cylindrical cell (as shown within FIG. 1C-1), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-1, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4.

FIG. 1C-2 illustrates a cross-cut perspective 100-C2 of FIG. 1B-1 in the context of a cylindrical cell, in accordance with one embodiment. As an option, the cross-cut perspective 100-C2 may be implemented in the context of any one or more of the embodiments set forth in any previous and/or subsequent figure(s) and/or description thereof. Of course, however, the cross-cut perspective 100-C2 may be implemented in the context of any desired environment. Further, the aforementioned definitions may equally apply to the description below.

As shown, the cross-cut perspective 100-C2 shows a cylindrical cell in a first clockwise configuration containing a cathode 100-B1, a first separator 100-B2, an anode 100-B3, and a second separator 100-B4. Within the context of a cylindrical cell (as shown within FIG. 1C-2), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-2, both sides of the anode 100-B3 and the cathode 100-B1 come in direct contact with the first separator 100-B2 and the second separator 100-B4.

FIG. 1C-3 illustrates a cross-cut perspective 100-C3 of FIG. 1B-1 in the context of a cylindrical cell, in accordance with one embodiment. As an option, the cross-cut perspective 100-C3 may be implemented in the context of any one or more of the embodiments set forth in any previous and/or subsequent figure(s) and/or description thereof. Of course, however, the cross-cut perspective 100-C3 may be implemented in the context of any desired environment. Further, the aforementioned definitions may equally apply to the description below.

As shown, the cross-cut perspective 100-C3 shows a cylindrical cell in a second counter-clockwise configuration containing a cathode 100-B1, a first separator 100-B2, an anode 100-B3, and a second separator 100-B4. Within the context of a cylindrical cell (as shown within FIG. 1C-3), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-3, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4. In contrasting FIG. 1C-3 to FIG. 1C-1, it is noted that the configuration of the layers (namely the layering of the cathode and anode) may differ, based on whether the cathode or the anode are on the inside or outside of the winding.

FIG. 1C-4 illustrates a cross-cut perspective 100-C4 of FIG. 1B-1 in the context of a cylindrical cell, in accordance with one embodiment. As an option, the cross-cut perspective 100-C4 may be implemented in the context of any one or more of the embodiments set forth in any previous and/or subsequent figure(s) and/or description thereof. Of course, however, the cross-cut perspective 100-C4 may be implemented in the context of any desired environment. Further, the aforementioned definitions may equally apply to the description below.

As shown, the cross-cut perspective 100-C4 shows a cylindrical cell in a second clockwise configuration containing a cathode 100-B1, a first separator 100-B2, an anode 100-B3, and a second separator 100-B4. Within the context of a cylindrical cell (as shown within FIG. 1C-4), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-4, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4. In contrasting FIG. 1C-4 to FIG. 1C-2, it is noted that the configuration of the layers (namely the layering of the cathode and anode) may differ, based on whether the cathode or the anode are on the inside or outside of the winding.

FIG. 1C-5 illustrates a cross-cut perspective 100-C5 of FIG. 1B-2 in the context of a cylindrical cell, in accordance with one embodiment. As an option, the cross-cut perspective 100-C5 may be implemented in the context of any one or more of the embodiments set forth in any previous and/or subsequent figure(s) and/or description thereof. Of course, however, the cross-cut perspective 100-C5 may be implemented in the context of any desired environment. Further, the aforementioned definitions may equally apply to the description below.

As shown, the cross-cut perspective 100-C5 shows a cylindrical cell in a first counter-clockwise configuration containing a cathode 100-B1, a first separator 100-B2, an anode 100-B3, a second separator 100-B4, and a cathode current collector 100-B6. Within the context of a cylindrical cell (as shown within FIG. 1C-5), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with a second side of the first separator 100-B2, and a second side of the cathode 100-B1 comes in contact with the cathode current collector 100-B6, which in turn, comes in contact with the second side of the second separator 100-B4. In this manner, the cathode 100-B1 may be in direct contact with both the first separator 100-B2 and the cathode current collector 100-B6.

As such, in the jelly roll configuration of FIG. 1C-5, a first side of the anode 100-B3 comes in direct contact with the first separator 100-B2 and the second side of the anode 100-B3 comes in direct contact with the second separator 100-B4.

FIG. 1C-6 illustrates a cross-cut perspective 100-C6 of FIG. 1B-2 in the context of a cylindrical cell, in accordance with one embodiment. As an option, the cross-cut perspective 100-C6 may be implemented in the context of any one or more of the embodiments set forth in any previous and/or subsequent figure(s) and/or description thereof. Of course, however, the cross-cut perspective 100-C6 may be implemented in the context of any desired environment. Further, the aforementioned definitions may equally apply to the description below.

As shown, the cross-cut perspective 100-C6 shows a cylindrical cell in a first clockwise configuration containing a cathode 100-B1, a first separator 100-B2, an anode 100-B3, a second separator 100-B4, and a cathode current collector 100-B6. Within the context of a cylindrical cell (as shown within FIG. 1C-6), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with a second side of the first separator 100-B2, and a second side of the cathode 100-B1 comes in contact with the cathode current collector 100-B6, which in turn, comes in contact with the second side of the second separator 100-B4. In this manner, the cathode 100-B1 may be in direct contact with both the first separator 100-B2 and the cathode current collector 100-B6.

As such, in the jelly roll configuration of FIG. 1C-6, a first side of the anode 100-B3 comes in direct contact with the first separator 100-B2 and the second side of the anode 100-B3 comes in direct contact with the second separator 100-B4.

FIG. 1C-7 illustrates a cross-cut perspective 100-C7 of FIG. 1B-2 in the context of a cylindrical cell, in accordance with one embodiment. As an option, the cross-cut perspective 100-C7 may be implemented in the context of any one or more of the embodiments set forth in any previous and/or subsequent figure(s) and/or description thereof. Of course, however, the cross-cut perspective 100-C7 may be implemented in the context of any desired environment. Further, the aforementioned definitions may equally apply to the description below.

As shown, the cross-cut perspective 100-C7 shows a cylindrical cell in a second counter-clockwise configuration containing a cathode 100-B1, a first separator 100-B2, an anode 100-B3, a second separator 100-B4, and a cathode current collector 100-B6. Within the context of a cylindrical cell (as shown within FIG. 1C-7), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with the second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4. Further, as shown, the cathode current collector 100-B6 may be embedded within the cathode 100-B1. For example, the cathode 100-B1 may be a double sided cathode with the cathode current collector 100-B6 sandwiched between a first layer of the cathode 100-B1 and a second layer of the cathode 100-B1. It is to be appreciate further that as discussed herein, the cathode 100-B1 may include a single sided cathode or a double side cathode, and the cathode current collector 100-B6 may be located to a single side of the cathode 100-B1, or may be sandwiched between a first layer and second layer of the cathode 100-B1.

As such, in the jelly roll configuration of FIG. 1C-7, a first side of the anode 100-B3 comes in direct contact with the first separator 100-B2 and the second side of the anode 100-B3 comes in direct contact with the second separator 100-B4. In contrasting FIG. 1C-7 to FIG. 1C-5, it is noted that the configuration of the layers (namely the layering of the cathode and anode) may differ, based on whether the cathode or the anode are on the inside or outside of the winding.

FIG. 1C-8 illustrates a cross-cut perspective 100-C8 of FIG. 1B-2 in the context of a cylindrical cell, in accordance with one embodiment. As an option, the cross-cut perspective 100-C8 may be implemented in the context of any one or more of the embodiments set forth in any previous and/or subsequent figure(s) and/or description thereof. Of course, however, the cross-cut perspective 100-C8 may be implemented in the context of any desired environment. Further, the aforementioned definitions may equally apply to the description below.

As shown, the cross-cut perspective 100-C8 shows a cylindrical cell in a second clockwise configuration containing a cathode 100-B1, a first separator 100-B2, an anode 100-B3, a second separator 100-B4, and a cathode current collector 100-B6. Within the context of a cylindrical cell (as shown within FIG. 1C-8), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with the second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4. Further, as shown, the cathode current collector 100-B6 may be embedded within the cathode 100-B1. For example, the cathode 100-B1 may be a double sided cathode with the cathode current collector 100-B6 sandwiched between a first layer of the cathode 100-B1 and a second layer of the cathode 100-B1.

As such, in the jelly roll configuration of FIG. 1C-8, a first side of the anode 100-B3 comes in direct contact with the first separator 100-B2 and the second side of the anode 100-B3 comes in direct contact with the second separator 100-B4. In contrasting FIG. 1C-8 to FIG. 1C-6, it is noted that the configuration of the layers (namely the layering of the cathode and anode) may differ, based on whether the cathode or the anode are on the inside or outside of the winding.

FIG. 1D illustrates a cross-cut perspective of a cylindrical cell 100-D with a free standing lithium anode, in accordance with one embodiment. It is to be appreciated that the cross-cut perspective of a cylindrical cell 100-D presents one possible configuration of a cylindrical cell (i.e. rolled up electrode body). As an option, the cylindrical cell 100-D may be implemented in the context of any one or more of the embodiments set forth in any previous and/or subsequent figure(s) and/or description thereof. Of course, however, the cylindrical cell 100-D may be implemented in the context of any desired environment. Further, the aforementioned definitions may equally apply to the description below.

It is to be appreciated that the FIG. 1D displays the cross-cut perspective 100-B in wound-form.

As shown, the cross-cut perspective of the cylindrical cell 100 may take the form of a jelly roll style construction comprised of a compressed lithium anode material 104 adhered to a separator 102. The construction may include a tab 106 attached to a current collector integrated within the cylindrical cell. Further, the construction may include a cathode material. For purposes of simplification, the cross-cut perspective of the cylindrical cell 100 displays compressed layers (which may include, in one embodiment, an anode layer and a cathode layer separated by a separator).

In one embodiment, the separator 102 may be adhered to a sheet of the lithium anode material 104. When the cylindrical cell is wound, the separator 102 may come in contact the lithium anode material 104.

Further, in one embodiment, prior to winding, the layering of the cell may include a layer for a cathode material, a layer for a first separator, a layer for an anode material, and a layer for a second separator. As the layers are wound (when the structure of all layers is rolled over itself repeatedly), the jelly roll structure of the lithium battery may be created where the cathode and anode layers comprise every other layer in a cross-section representation.

In another embodiment, the lithium anode material 104 may be comprised of any metal(s) suitable for battery-storage purposes, including lithium-containing alloys like lithium-magnesium (Li—Mg) and lithium-sulfur (Li—S). In a related embodiment, the lithium anode material 104 may be manufactured as a roll of material affixed to another carrier film compound capable of simultaneously maintaining the integrity of the lithium-containing alloy in question and serving as a separator compound between the anode material 104 and a cathode. It should be noted that incorporating the carrier film may help preserve the integrity of lithium-containing alloys where the requisite (industry-standard) tensile strength of such winding/wrapping may conform to 27-28 Newtons of stretching force.

Further, in one embodiment the lithium anode material 104 may theoretically include pure lithium. In such an embodiment, the lithium anode material 104 may require a carrier film. The carrier film may function as a separator (for lithium anode material 104), and may be used to increase the tensile strength of the pure lithium such that it retains mechanical integrity as it goes through the winding process. In another embodiment, lithium anode material 104 may be an alloy composition such that the composition inherently can withstand the winding demands. In such an embodiment, a carrier film may not be needed but a separator can still be used to ensure proper insulation and electron flow.

In still another embodiment, the separator 102 may be comprised of any non-conductive, non-corrosive material suitable for insulating the anode material 104 (as well as for a cathode material layer). Additionally, the separator may allow for electron flow (between the cathode material and the anode material, and vice versa) and/or function as an insulator. Additionally, more than one separator may be present within the cylindrical configuration. For example, in a four layer assembly (e.g. cathode, first separator, anode, second separator, etc.), a first separator may function as an insulator, and a second insulator may function to allow electron flow. It is to be appreciated that within the context of FIG. 1D (and other figures described herein), for simplicity purposes, the separators are designated in the singular (as a “separator”). However, even within such context (of one separator being called out), it is to be understood that a common cylindrical assembly would be comprised of a cathode, a first separator, an anode, and a second separator, consistent with the layered details associated with FIG. 1B.

In various embodiments, two or more separators may be uncoated or coated with either a polymer (such as but not limited to PVDF, PEO, PMMA, PAA, PVA, etc.), a salt (such as but not limited to LIFSI, LITFSI, LIPF6, etc.), a metal (such as but not limited to tungsten, aluminum, selenium, tellerium), and/or a ceramic (such as but not limited to alumina, aluminum fluoride, etc.). In one embodiment, one of the two or more separators may face towards the cathode or anode (with a second separator facing towards the other), and in some cases may face both the cathode and the anode (such as when sandwiched between the anode and cathode, when acting as an adhesive to keep the separator tightly bound to the anode, when functioning as a mechanism to block polysulfides, when functioning to even out current density, etc.).

Additionally, the two or more separators may be constructed of various materials, including but not limited to polymer, ceramic, metal and/or salt. Additionally, the two or more separators may be coated on one or more sides. Additionally, the coating may be for one of electrochemical, mechanical, and/or or safety considerations. Further, the coating may allow for adhesion to an electrode, thermal distribution, mechanical reinforcement of an electrode or the separator itself, even out a current distribution, and/or block polysulfides.

In this manner, the two or more separators may be constructed of the same (or potentially different) materials, and may have same (or potentially different) functions, configured as needed depending on the needs of the cylindrical cell.

In various embodiments, the cross-cut perspective of the cylindrical cell 100 may be configured without a current collector. In such an embodiment, the lithium electrode may function as the current collector (and be connected directly to the tab 106).

As such, a freestanding lithium cylindrical battery may be achieved such that traditional use of copper (within the context of a cylindrical battery) may not be necessary. It is further noted that the freestanding lithium cylindrical battery may still integrate copper, but in a manner the conventionally is not done in the industry. For example, as explained hereinbelow more fully, copper may be compressed between two lithium layers, stamped, and/or inlayed from a roll.

Further, in various embodiments, a freestanding lithium cylindrical cell may be provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In one embodiment, the anode may consist essentially of pure lithium. Additionally, the anode may comprise a lithium alloy including one or more of sulfur, magnesium, aluminum, alumina, lithium titanate, lithium lanthanum zirconium oxide (LLZO), calcium, tellerium, silicon, tin, zinc, or nickel. Further, the anode may comprise a lithium-magnesium anode, and/or a pure lithium anode. Further, the anode may comprise one of a lithium metal alloy anode, or a lithium composite anode.

In another embodiment, the jelly roll may include a current collector. The current collector may comprise at least one of copper, or nickel. Additionally, the jelly roll may comprise an assembly, wherein the assembly excludes copper.

In another embodiment, the battery may further comprise copper inlays within the jelly roll for tab welding. Additionally, at least one of the first separator or the second separator may be a carrier film for the anode. Further, the battery may further comprise an electrolyte disposed in the battery. The electrolyte may be configured to inhibit transport of lithium-containing polysulfide intermediate species from the cathode to the anode.

In another embodiment, the anode may be a solid lithium layer, and a current collector may be coupled to the anode. Additionally, the jelly roll may be wound using one or more mandrels.

In another embodiment, a top surface of the jelly roll may be not in contact with a top lid of the cylindrical shell. Additionally, a bottom surface of the jelly roll may be at least partially in contact with a negative contact surface of the cylindrical shell. Further, a casing of the battery may be formed from one or more of aluminum or steel. In one embodiment, a positive terminal of the battery may be welded to a current collector electrically coupled to the cathode, and a negative contact surface may be welded to a current collector coupled to the anode.

In another embodiment, the anode may comprise an alloy selected to surpass a minimum shear strength, where the minimum shear strength surpasses 50 N/cm2 Additionally, the anode may be an alloy selected to surpass a minimum mechanical strength, where the minimum mechanical strength surpasses 160 N/cm2.

In another embodiment, at least one of the first separator or the second separator may be configured for ion flow. Additionally, the battery may further comprise an inlay comprising copper, where the inlay may be one of a vertical strip or a horizontal strip. The vertical strip may be stamped into the anode, and the horizontal strip may be inlayed within the anode.

In another embodiment, the anode may function as a current collector. Additionally, the anode may consist of pure lithium, and at least one of the first separator or the second separator include a carrier film, where the carrier film increases the tensile strength of the pure lithium. Further, the anode may be a lithium alloy, and at least one of the first separator or the second separator may not include a carrier film.

In another embodiment, the cylindrical shell may have a diameter in a range from approximately 18.4 millimeter (mm) to approximately 18.6 mm and a length in a range from approximately 65.1 mm to approximately 65.3 mm. Additionally, the cylindrical shell may be congruent with an 18560 cell. Further, at least one of the anode or the cathode may not include a tab.

In another embodiment, the freestanding assembly may be a substrate-less electrode. Additionally, the freestanding assembly is a copper-free assembly. Further, the anode may lack a separate layer for a current collector. For example, the may lithium function as a current collector.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a side perspective of a cylindrical cell 200 with a free standing lithium anode, in accordance with one embodiment. As an option, the cylindrical cell 200 may be implemented in the context of any one or more of the embodiments set forth in any previous and/or subsequent figure(s) and/or description thereof. Of course, however, the cylindrical cell 200 may be implemented in the context of any desired environment. Further, the aforementioned definitions may equally apply to the description below.

As shown, the side perspective of the cylindrical cell 200 may take the form of a jelly roll style construction comprised of a compressed lithium anode material 204 adhered to a separator compound 202, which may be rolled upon itself repeatedly starting from a central collector structure. A first tab 206 and a second tab 208 may correspond with a positive and negative terminal of the battery.

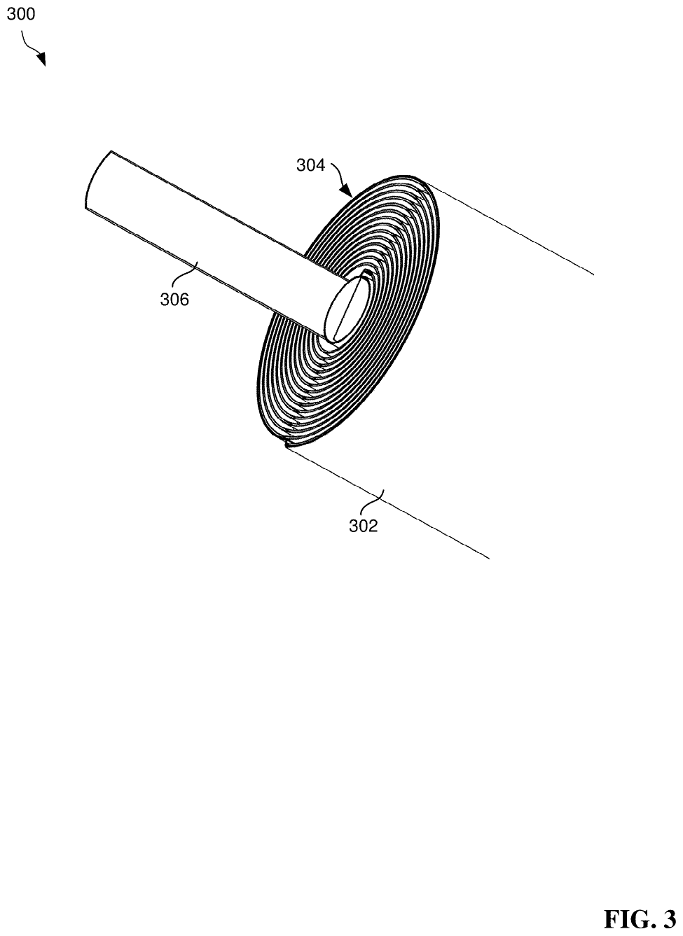

FIG. 3 illustrates a close-up perspective of a cylindrical cell 300 with a free standing lithium anode, in accordance with one embodiment. As an option, the cylindrical cell 300 may be implemented in the context of any one or more of the embodiments set forth in any previous and/or subsequent figure(s) and/or description thereof. Of course, however, the cylindrical cell 300 may be implemented in the context of any desired environment. Further, the aforementioned definitions may equally apply to the description below.

As shown, the close-up perspective of the cylindrical cell 300 may take the form of a jelly roll style construction comprised of a compressed lithium anode material 304 adhered to a separator compound 302, which may be rolled upon itself repeatedly starting from a central collector structure. Additionally, a tab 306 to conduct the electric charge is displayed.

FIG. 4 illustrates a top-down perspective of a cylindrical cell 400 with a free standing lithium anode, in accordance with one embodiment. As an option, the cylindrical cell 400 may be implemented in the context of any one or more of the embodiments set forth in any previous and/or subsequent figure(s) and/or description thereof. Of course, however, the cylindrical cell 400 may be implemented in the context of any desired environment. Further, the aforementioned definitions may equally apply to the description below.

As shown, the top-down perspective of the cylindrical cell 400 may take the form of a jelly roll style construction comprised of a compressed lithium anode material 404 adhered to a separator compound 402, which may be rolled upon itself repeatedly starting from a central collector structure. Additionally, a tab 406 to conduct the electric charge is displayed.

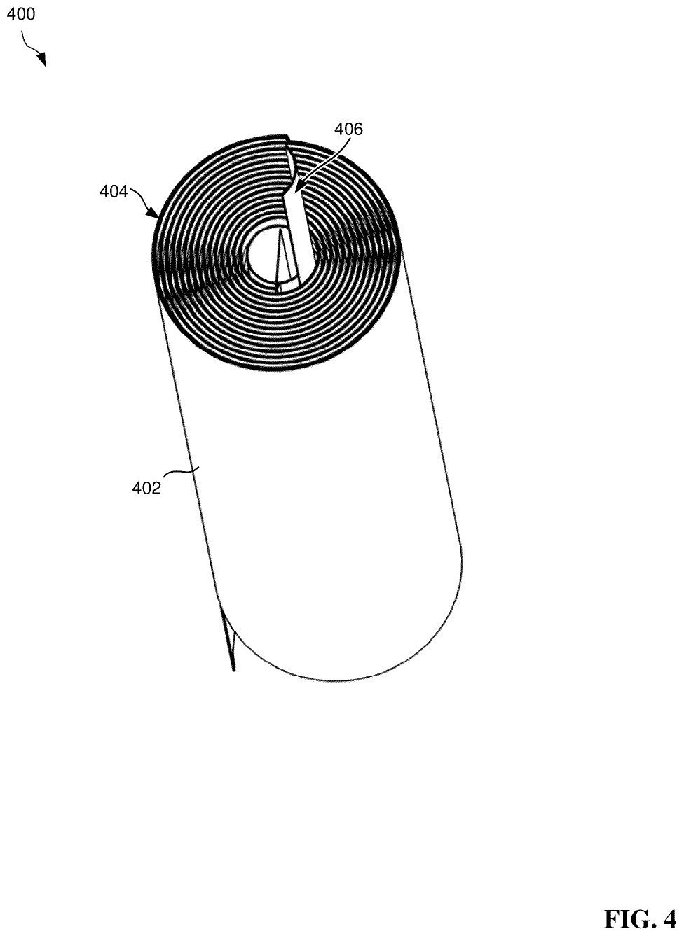

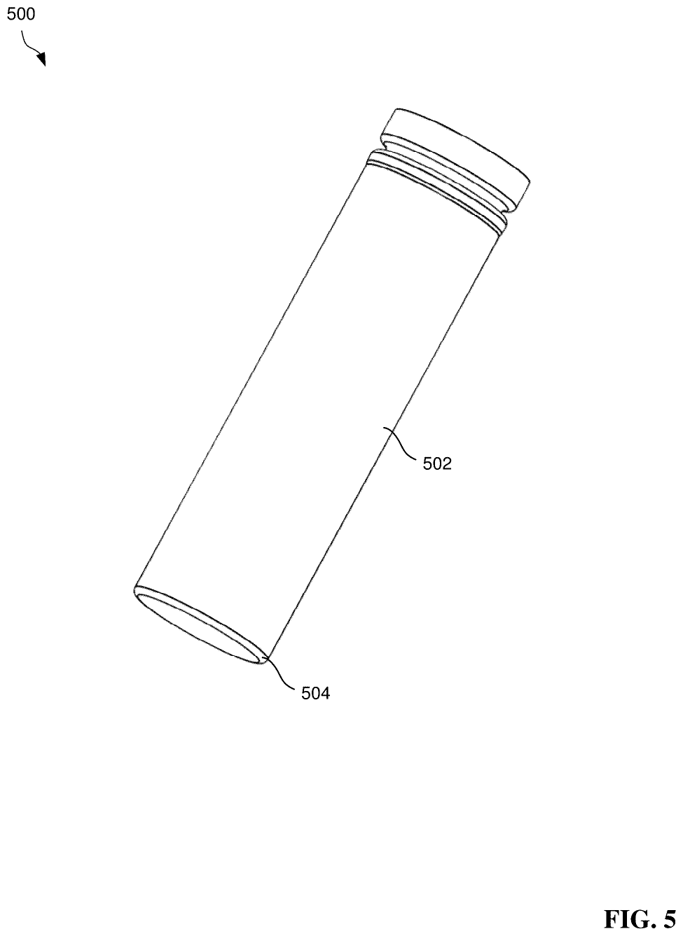

FIG. 5 illustrates a case 500 for a cylindrical cell with a free standing lithium anode, in accordance with one embodiment. As an option, the case 500 may be implemented in the context of any one or more of the embodiments set forth in any previous and/or subsequent figure(s) and/or description thereof. Of course, however, the case 500 may be implemented in the context of any desired environment. Further, the aforementioned definitions may equally apply to the description below.

As shown, the case 500 for the cylindrical cell may comprise a protective, non-conductive container 502 with a positive terminal 504 capping one end of the container 502. The case 500 may be used to house the cylindrical cell battery discussed herein.

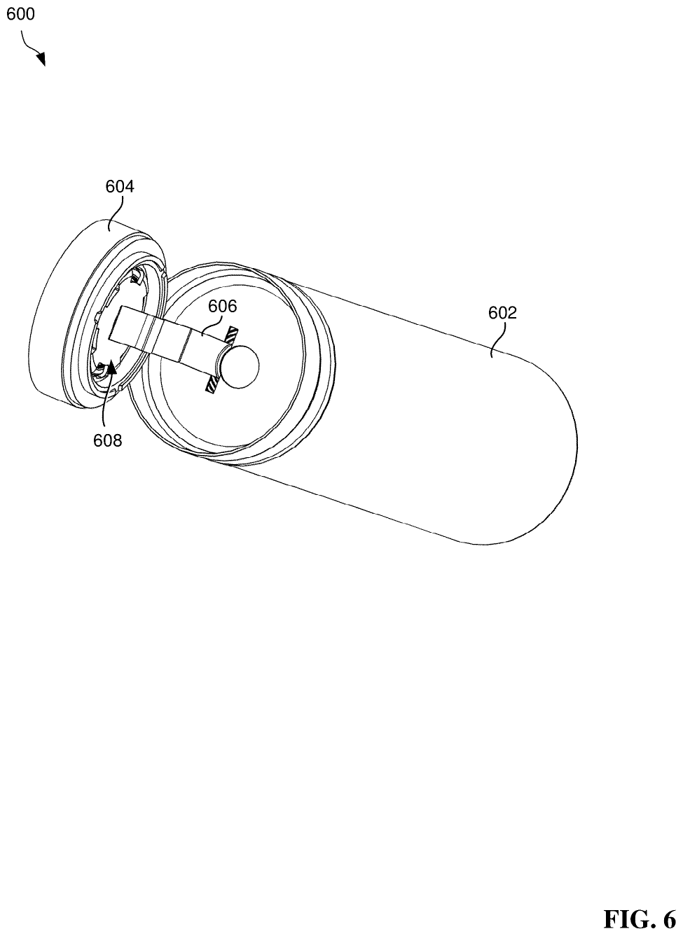

FIG. 6 illustrates an assembled cylindrical cell 600 with a free standing lithium anode, in accordance with one embodiment. As an option, the assembled cylindrical cell 600 may be implemented in the context of any one or more of the embodiments set forth in any previous and/or subsequent figure(s) and/or description thereof. Of course, however, the assembled cylindrical cell 600 may be implemented in the context of any desired environment. Further, the aforementioned definitions may equally apply to the description below.

As shown, the assembled cylindrical cell 600 may comprise a protective, non-conductive container 602. A tab 606 may protrude outside of the container 602 and be connected directly to the cylindrical cell. In addition, the tab 606 may be welded, or otherwise affixed, to a terminal 608 of a top cap 604. Further, the top cap 604 may encompass a current collector and may fully enclose the container 602 at one end.

In one embodiment, the tab 606 may be comprised of a copper or nickel construct. In another embodiment, the tab 606 may be comprised of other conductive materials including, but not limited to, brass.

FIG. 7 illustrates an assembled cylindrical cell 700 with a free standing lithium anode, in accordance with one embodiment. As an option, the assembled cylindrical cell 700 may be implemented in the context of any one or more of the embodiments set forth in any previous and/or subsequent figure(s) and/or description thereof. Of course, however, the assembled cylindrical cell 700 may be implemented in the context of any desired environment. Further, the aforementioned definitions may equally apply to the description below.

As shown, the assembled cylindrical cell 700 may comprise a protective, non-conductive container 702 out of which a tab 706 (connected to a cylindrical cell battery) may protrude. In addition, the tab 706 may be welded, or otherwise affixed, to a current collector 708. Further, a top cap 704 may encompass the current collector 708 and may fully enclose the container 702 one end.

FIG. 8 illustrates a jelly roll configuration 800 for a cylindrical cell with a free standing lithium anode, in accordance with one embodiment. As an option, the jelly roll configuration 800 may be implemented in the context of any one or more of the embodiments set forth in any previous and/or subsequent figure(s) and/or description thereof. Of course, however, the jelly roll configuration 800 may be implemented in the context of any desired environment. Further, the aforementioned definitions may equally apply to the description below.

As shown, the jelly roll configuration 800 may comprise an anode-and-cathode structure 802 in the form of a roll of lithium structure axiomatically separated from each successive layer by an adhered separator compound. As discussed herein, the separator may function as an insulator, and/or may allow for electron flow (between the cathode and anode, and visa versa).

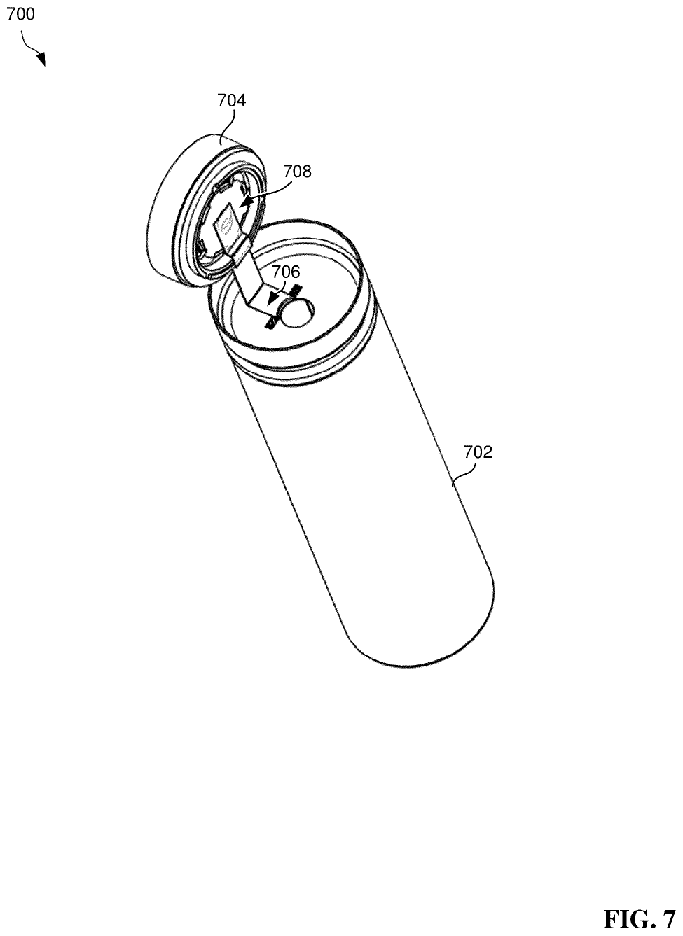

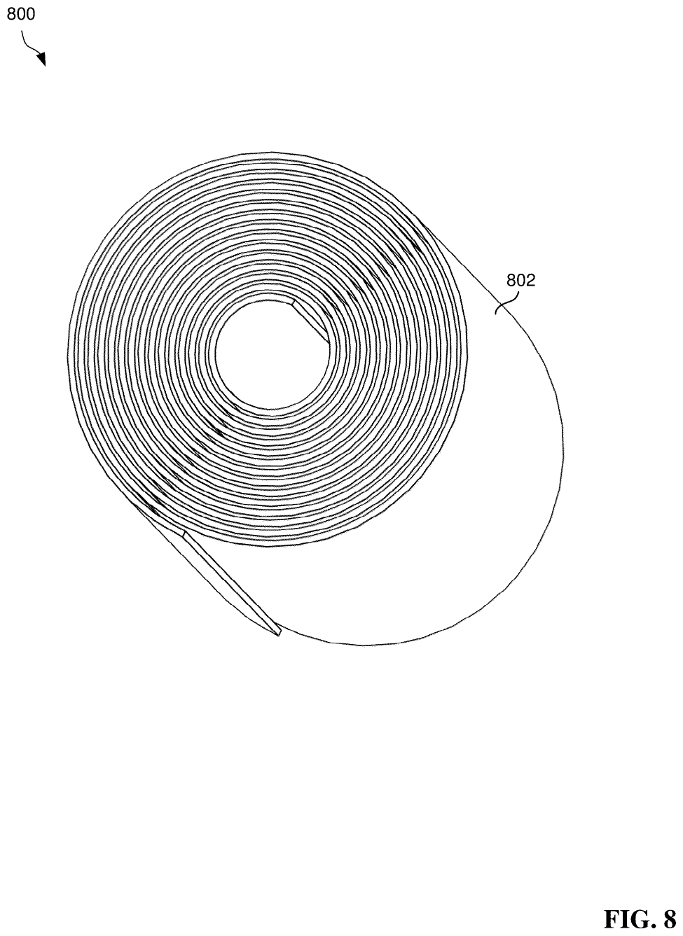

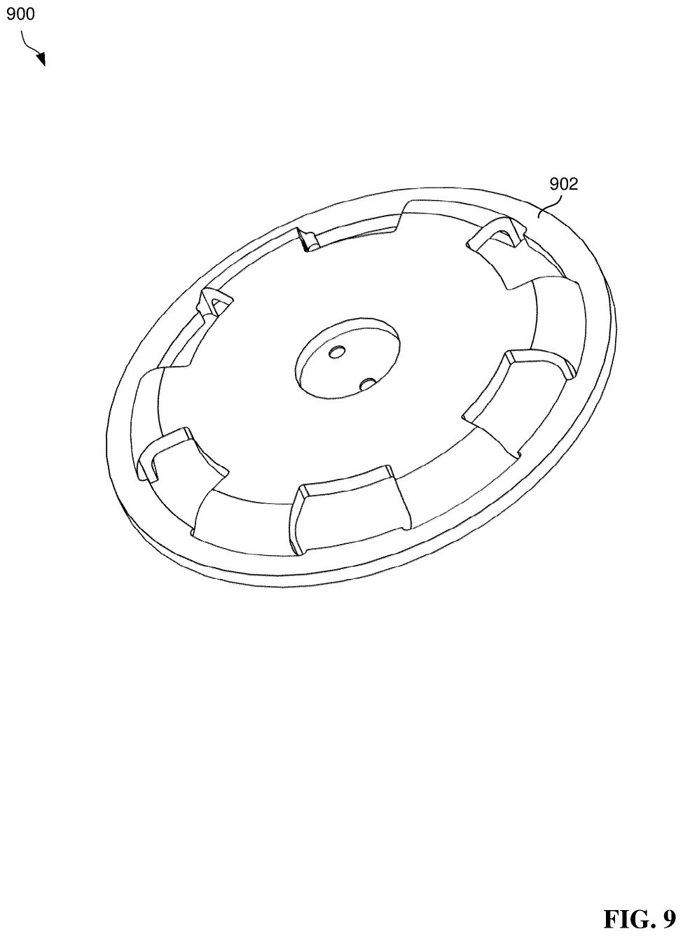

FIG. 9 illustrates a current collector 900 for a cylindrical cell with a free standing lithium anode, in accordance with one embodiment. As an option, the current collector 900 may be implemented in the context of any one or more of the embodiments set forth in any previous and/or subsequent figure(s) and/or description thereof. Of course, however, the current collector 900 may be implemented in the context of any desired environment. Further, the aforementioned definitions may equally apply to the description below.

As shown, the current collector 900 may comprise a housing 902 designed to remain in contact with the anode and cathode lithium structures within the cylindrical battery construction. Additionally, within the context of the assembled cylindrical cell 700, the current collector 900 may be, in one embodiment, located on the bottom-most component of the case structure (i.e. below the cylindrical cell).

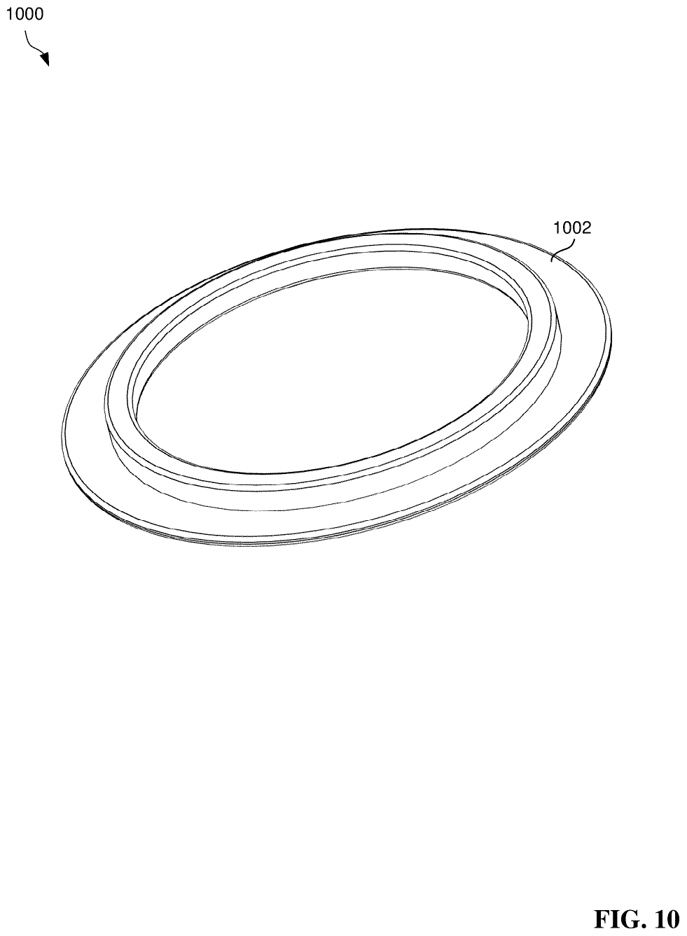

FIG. 10 illustrates a gasket 1000 for a cylindrical cell with a free standing lithium anode, in accordance with one embodiment. As an option, the gasket 1000 may be implemented in the context of any one or more of the embodiments set forth in any previous and/or subsequent figure(s) and/or description thereof. Of course, however, the gasket 1000 may be implemented in the context of any desired environment. Further, the aforementioned definitions may equally apply to the description below.

As shown, the gasket 1000 may comprise a ring 1002 of non-conductive material, which may be installed on top of the current collector 900 in order to keep the edges of the current collector 900 from coming in direct contact with a side of a casing.

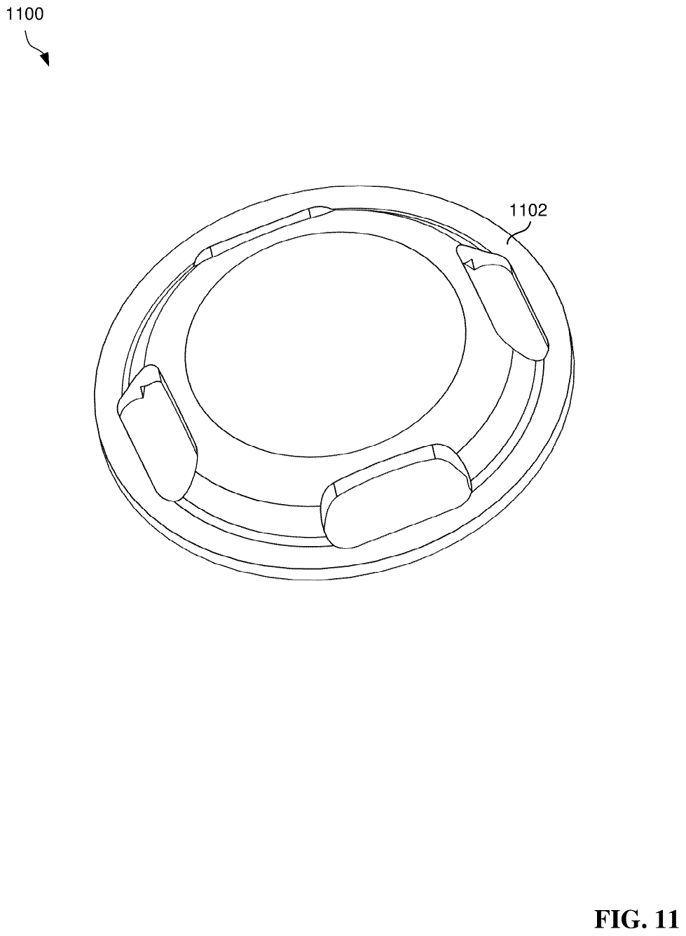

FIG. 11 illustrates a positive terminal 1100 for a cylindrical cell with a free standing lithium anode, in accordance with one embodiment. As an option, the positive terminal 1100 may be implemented in the context of any one or more of the embodiments set forth in any previous and/or subsequent figure(s) and/or description thereof. Of course, however, the positive terminal 1100 may be implemented in the context of any desired environment. Further, the aforementioned definitions may equally apply to the description below.

As shown, the positive terminal 1100 may comprise a conductive surface cap 1102 for the battery to enable electron flow for discharging and recharging of the battery cell during operation.

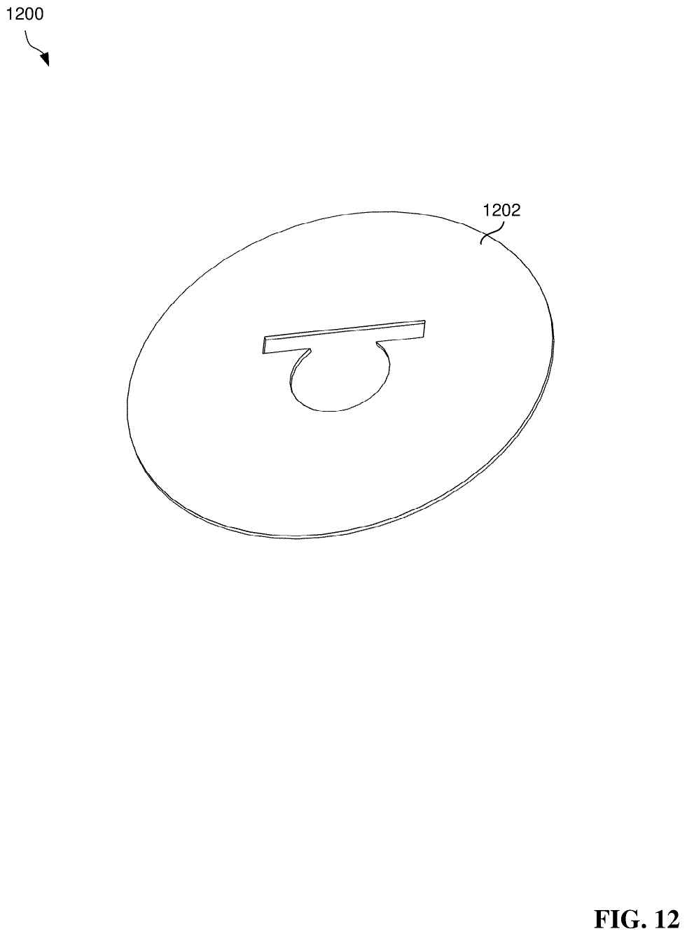

FIG. 12 illustrates a top insulator 1200 for a cylindrical cell with a free standing lithium anode, in accordance with one embodiment. As an option, the top insulator 1200 may be implemented in the context of any one or more of the embodiments set forth in any previous and/or subsequent figure(s) and/or description thereof. Of course, however, the top insulator 1200 may be implemented in the context of any desired environment. Further, the aforementioned definitions may equally apply to the description below.

As shown, the top insulator 1200 may comprise a circular structure 1202 with a port and slot carved into the center which may allow for connection to (contact with) the tab 706 and the inner contact structure to be connected to the current collector 708.

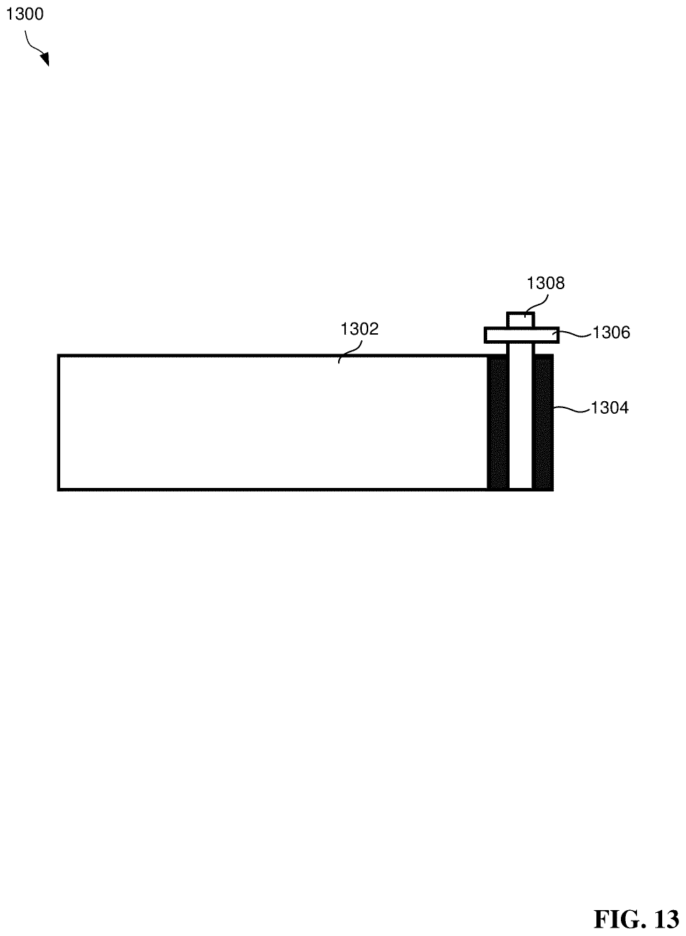

FIG. 13 illustrates a reduced copper-configured cylindrical cell 1300, in accordance with one embodiment. As an option, the reduced copper-configured cylindrical cell 1300 may be implemented in the context of any one or more of the embodiments set forth in any previous and/or subsequent figure(s) and/or description thereof. Of course, however, the reduced copper-configured cylindrical cell 1300 may be implemented in the context of any desired environment. Further, the aforementioned definitions may equally apply to the description below.

As shown, the reduced copper-configured cylindrical cell 1300 may comprise a roll 1302 of lithium encased in a pair of separator compounds with a copper stamping 1304 of the roll 1302. The copper stamping 1304 may facilitate consistent conductivity from the inner-most to outer-most layers of the roll 1302. Additionally, the reduced copper-configured cylindrical cell 1300 may comprise a contact structure 1308, around which the roll 1302 may be wrapped. In addition, the cylindrical cell 1300 may comprise a cell cap 1306 to enclose the exposed end of the jelly roll lithium-and-separator structure prior to final battery assembly.

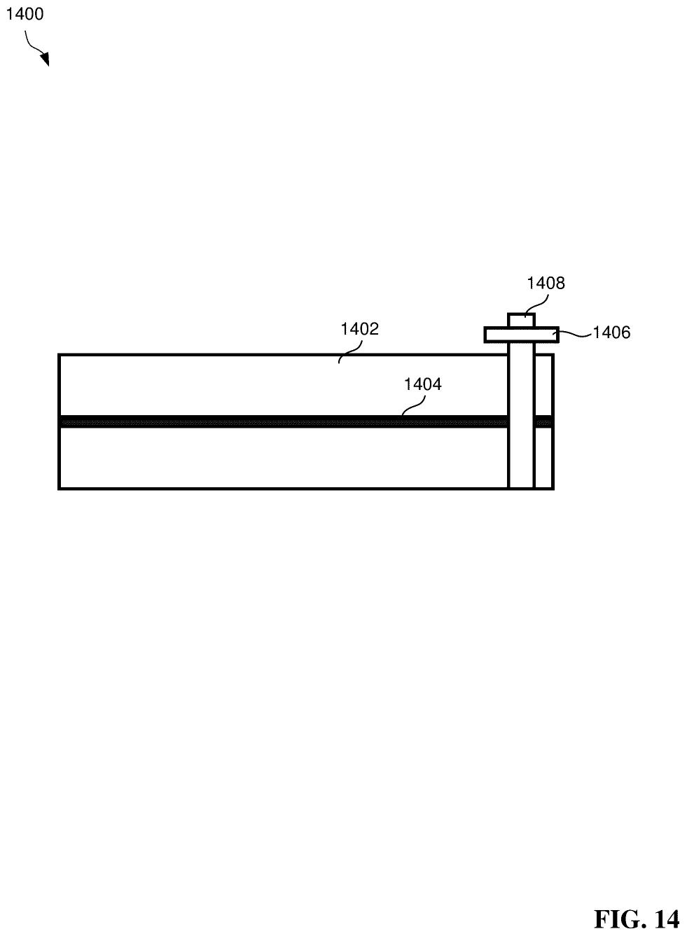

FIG. 14 illustrates a reduced copper-configured cylindrical cell 1400, in accordance with one embodiment. As an option, the reduced copper-configured cylindrical cell 1400 may be implemented in the context of any one or more of the embodiments set forth in any previous and/or subsequent figure(s) and/or description thereof. Of course, however, the reduced copper-configured cylindrical cell 1400 may be implemented in the context of any desired environment. Further, the aforementioned definitions may equally apply to the description below.

As shown, the reduced copper-configured cylindrical cell 1400 may comprise a roll 1402 of lithium encased in a pair of separator compounds with a copper strip 1404 integrated into the roll 1402 (similar in form of inlay banding). The copper strip, in one embodiment, may facilitate consistent conductivity from the inner-most to outer-most layers of the roll 1402. Additionally, the reduced copper-configured cylindrical cell 1400 may comprise a contact structure 1408, around which the roll 1402 may be wrapped. In addition, the cylindrical cell 1400 may comprise a cell cap 1406 to enclose the exposed end of the jelly roll lithium-and-separator structure prior to final battery assembly.

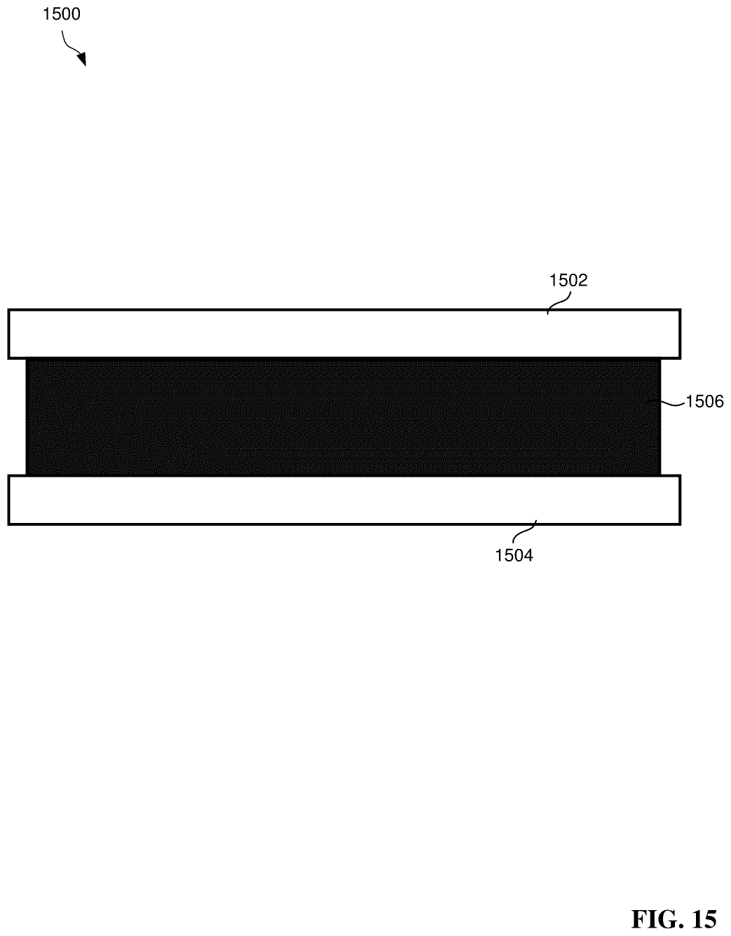

FIG. 15 illustrates a free standing lithium anode 1500, in accordance with one embodiment. As an option, the free standing lithium anode 1500 may be implemented in the context of any one or more of the embodiments set forth in any previous and/or subsequent figure(s) and/or description thereof. Of course, however, the free standing lithium anode 1500 may be implemented in the context of any desired environment. Further, the aforementioned definitions may equally apply to the description below.

As shown, the free standing lithium anode 1500 may comprise a strip of lithium material 1506 sandwiched between a first separator compound layer 1502 and a second separator compound layer 1504.

In one embodiment, the first separator compound layer 1502 and the second separator compound layer 1504 adhere to the lithium metal in a roll-to-roll process where two rolls of separator and one roll of lithium are fed into a single roll through a set of rollers which may then apply a predetermined amount of pressure (from 1 psi to 10 psi) on the separator-lithium-separator structure such that the separator is sufficiently adhered to the lithium on both sides.

In another embodiment, the first separator compound layer 1502 may provide tension relief along its x-, y-, and z-planes in an effort to prevent the separator-lithium-separator structure from shearing during manufacturing. In a related embodiment, the second separator compound layer 1504 may reduce modification of existing manufacturing processes due to the fact that the lithium layer would be prevented from coming into contact with potentially contaminated manufacturing surfaces, thus compromising the separator-lithium-separator structure even before battery construction.

In still another embodiment, the rolling or winding process that creates the jelly roll form of the free standing lithium anode 1500 may include increasing the relative tension (or “tightness”) of the rolled anode material as it naturally expands form the center, where less tension is required, to the outer-most layers, where the greatest tension is required to keep a uniform jelly roll structure throughout the lithium battery cell.

It is to be appreciated that if the strip of lithium material 1506 is pure lithium, the free standing lithium anode 1500 may be modified to include a carrier film for the lithium material. In the event, however, that the strip of lithium material 1506 is an alloy, then a carrier film may not be needed.

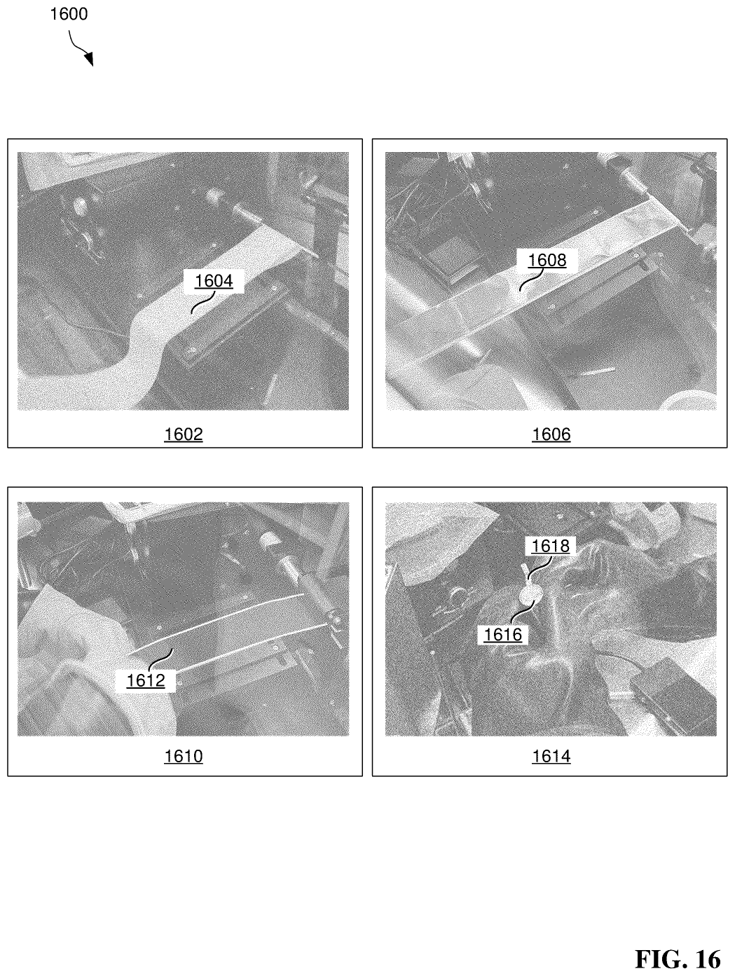

FIG. 16 illustrates production images 1600 for a cylindrical cell with a free standing lithium anode, in accordance with one embodiment. As an option, the production images 1600 may be implemented in the context of any one or more of the embodiments set forth in any previous and/or subsequent figure(s) and/or description thereof. Of course, however, the production images 1600 may be implemented in the context of any desired environment. Further, the aforementioned definitions may equally apply to the description below.

As shown, the production images 1600 for a battery assembly process may comprise a first assembly step 1602 wherein a separator layer 1604 may be set in position prior to first winding/wrapping process. Additionally, a second assembly step 1606 may be employed wherein a lithium structure 1608 is placed on top of the separator layer 1604. Further, a third assembly step 1610 may be performed wherein the last layer(s) 1612 of the wrapped separator-lithium-separator structure may be cut at a precise point to complete the jelly roll structure. In addition, a fourth assembly step 1614 may be completed where a connection tab 1618 is set apart from the jelly roll structure 1616. Further, in one embodiment, a first connection tab may be in contact with an anode, and a separate second connection tab may be in contact with a cathode. It is to be appreciated that the production images 1600 contained herein show a separation layer 1604 and the lithium structure 1608, which may include, as described herein, a single separation layer, an anode, a second separation layer, and a cathode.

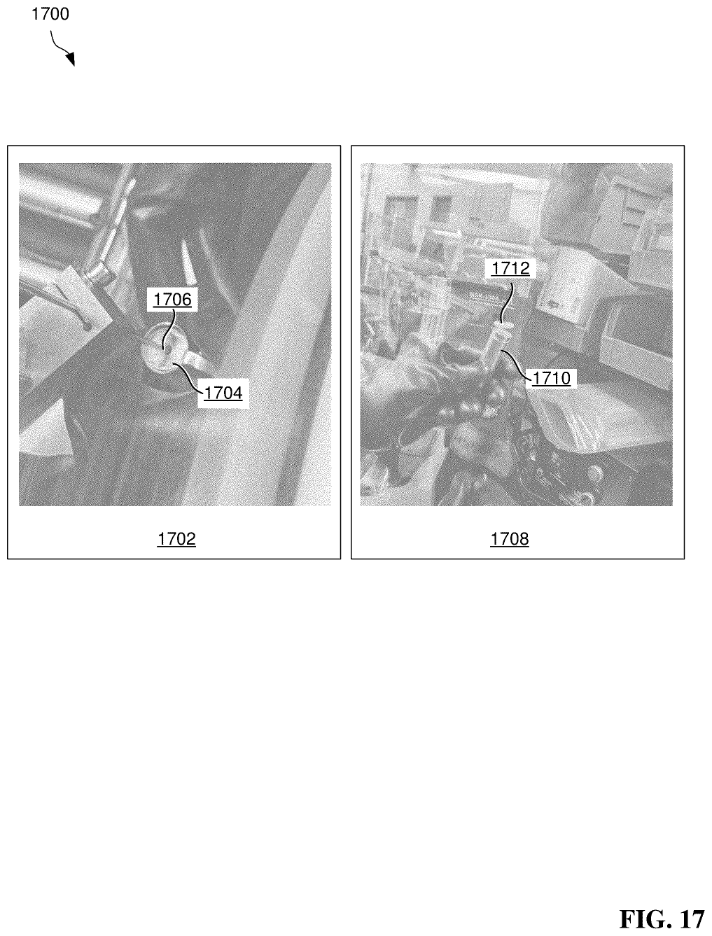

FIG. 17 illustrates production images 1700 for a cylindrical cell with a free standing lithium anode, in accordance with one embodiment. As an option, the production images 1700 may be implemented in the context of any one or more of the embodiments set forth in any previous and/or subsequent figure(s) and/or description thereof. Of course, however, the production images 1700 may be implemented in the context of any desired environment. Further, the aforementioned definitions may equally apply to the description below.

As shown, the production images 1700 for a battery assembly process may comprise a fifth assembly step 1702 (continuing from FIG. 16) wherein a battery casing insulator 1704 may be welded (or otherwise permanently affixed) to the positive terminal end of the lithium battery assembly with a connection tab 1706 left protruding and accessible for welding to a current collector. Additionally, a sixth assembly step 1708 may be completed where a positive current collector component 1712 may be welded (or otherwise permanently affixed) to an outer battery casing 1710.

In one embodiment, the current collector component 1712 may be comprised of nickel or other similar material for such purpose. In a related embodiment, the connection tab 1706 may be comprised of aluminum, which may be carefully folded over the battery casing insulator 1704 within the top battery assembly to prevent incorrect assembly when the top current collector component 1712 may be ultimately installed and affixed to the completed battery cell structure.

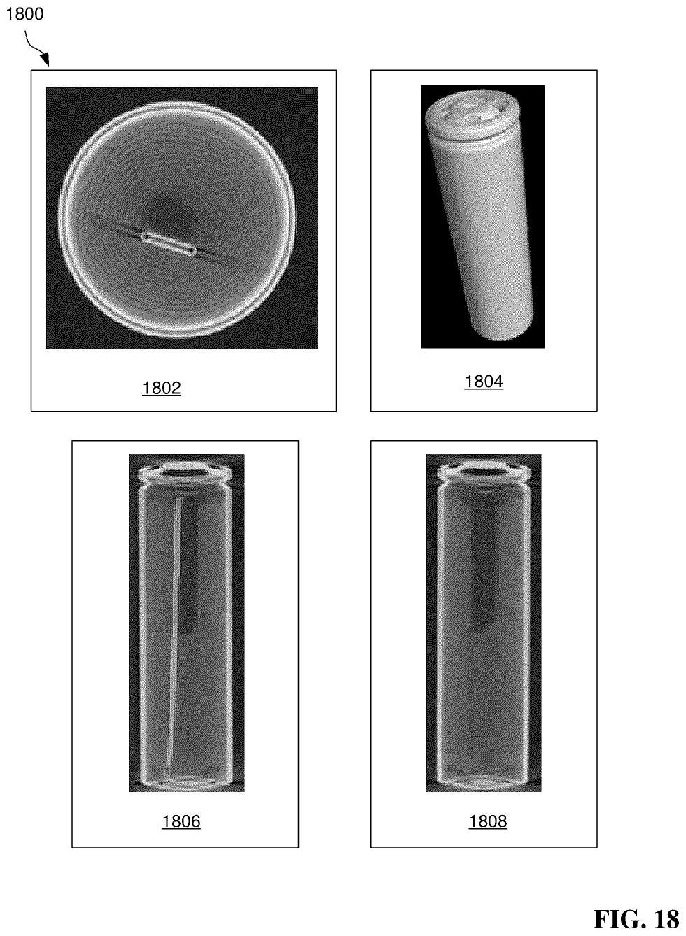

FIG. 18 illustrates computed tomography scans 1800 of a cylindrical cell with a free standing lithium anode, in accordance with one embodiment. As an option, the computed tomography scans 1800 may be implemented in the context of any one or more of the embodiments set forth in any previous and/or subsequent figure(s) and/or description thereof. Of course, however, the computed tomography scans 1800 may be implemented in the context of any desired environment. Further, the aforementioned definitions may equally apply to the description below.

As shown, the computed tomography (CT) scans 1800 may comprise a first CT scan 1802 displaying a cross section of the jelly roll structure of an assembled lithium battery. Additionally, a second CT scan 1804 may show a detailed image of the casing of an assembled lithium battery with its associated collector and connection tab within the assembled lithium battery. In addition, a third CT scan 1806 may show a portrait-oriented CT scan of the internal structure of the jelly roll including the associated collector and connection tab within the assembled lithium battery. Further, a fourth CT scan 1808 may show a portrait-oriented CT scan of the external structure of an assembled lithium battery.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A battery comprising:
a cylindrical shell defining an inner volume; and
a jelly roll disposed within the inner volume of the cylindrical shell, the jelly roll comprising:
an anode comprising lithium, wherein the anode is configured as a freestanding assembly,
a cathode comprising sulfur, a first separator between a first side of the anode and a first side of the cathode, and
a second separator in direct contact with a second side of the anode and with a second side of the cathode.

2. The battery of claim 1, wherein the anode consists essentially of pure lithium.

3. The battery of claim 1, wherein the anode comprises a lithium alloy including one or more of sulfur, magnesium, aluminum, alumina, lithium titanate, lithium lanthanum zirconium oxide (LLZO), calcium, tellerium, silicon, tin, zinc, or nickel.

4. The battery of claim 1, wherein the jelly roll includes a current collector.

5. The battery of claim 4, wherein the current collector comprises at least one of copper, or nickel.

6. The battery of claim 1, wherein the jelly roll comprises an assembly, wherein the assembly excludes copper.

7. The battery of claim 1, wherein the anode comprises a lithium-magnesium anode.

8. The battery of claim 1, wherein the anode comprises a pure lithium anode.

9. The battery of claim 1, wherein the anode comprises one of a lithium metal alloy anode, or a lithium composite anode.

10. The battery of claim 1, further comprising copper inlays within the jelly roll for tab welding.

11. The battery of claim 1, wherein at least one of the first separator or the second separator is a carrier film for the anode.

12. The battery of claim 1, further comprising an electrolyte disposed in the battery.

13. The battery of claim 12, wherein the electrolyte is configured to inhibit transport of lithium-containing polysulfide intermediate species from the cathode to the anode.

14. The battery of claim 1, wherein the anode is a solid lithium layer, and a current collector is coupled to the anode.

15. The battery of claim 1, wherein the jelly roll is wound using one or more mandrels.

16. The battery of claim 1, wherein a top surface of the jelly roll is not in contact with a top lid of the cylindrical shell.

17. The battery of claim 1, wherein a bottom surface of the jelly roll is at least partially in contact with a negative contact surface of the cylindrical shell.

18. The battery of claim 1, wherein a casing of the battery is formed from one or more of aluminum or steel.

19. The battery of claim 1, wherein a positive terminal of the battery is welded to a current collector electrically coupled to the cathode, and a negative contact surface is welded to a current collector coupled to the anode.

20. The battery of claim 1, wherein the anode comprises an alloy selected to surpass a minimum shear strength, where the minimum shear strength surpasses 50 N/cm2.

21. The battery of claim 1, wherein the anode is an alloy selected to surpass a minimum mechanical strength, where the minimum mechanical strength surpasses 160 N/cm2.

22. The battery of claim 1, wherein at least one of the first separator or the second separator are configured for ion flow.

23. The battery of claim 1, further comprising an inlay comprising copper, where the inlay is one of a vertical strip or a horizontal strip.

24. The battery of claim 23, wherein the vertical strip is stamped into the anode, and the horizontal strip is inlayed within the anode.

25. The battery of claim 1, wherein the anode functions as a current collector.

26. The battery of claim 1, wherein the anode consists of pure lithium, and at least one of the first separator or the second separator include a carrier film, wherein the carrier film increases the tensile strength of the pure lithium.

27. The battery of claim 1, wherein the anode is a lithium alloy, and at least one of the first separator or the second separator do not include a carrier film.

28. The battery of claim 1, wherein the cylindrical shell has a diameter in a range from approximately 18.4 millimeter (mm) to approximately 18.6 mm and a length in a range from approximately 65.1 mm to approximately 65.3 mm.

29. The battery of claim 1, wherein the cylindrical shell is congruent with an 18560 cell.

30. The battery of claim 1, wherein at least one of the anode or the cathode does not include a tab.

31. The battery of claim 1, wherein the freestanding assembly is a substrate-less electrode.

32. The battery of claim 1, wherein the freestanding assembly is a copper-free assembly.

33. The battery of claim 1, wherein the anode lacks a separate layer for a current collector.

34. The battery of claim 1, wherein the lithium functions as a current collector.
